(19) United States
(12) Patent Application Publication
(10) Pub. No.: US 2010/0198118 A1
(43) Pub. Date: Aug. 5, 2010

(54) Augmenting force-delivery in belt-type ECM devices

(76) Inventor: Michael Itai Itnati, Ramat Gan (IL)

Correspondence Address: EITAN MEHULAL LAW GROUP, 10 Abba Eban Blvd. PO Box 2081, Herzlia, 46120, IL

(21) Appl. No.: 12/320,813

(22) Filed: Feb. 5, 2009

(51) Int. Cl. A61H 31/00

(52) U.S. Cl. 601/41

(57) ABSTRACT

A belt-type external massage (ECM) device. A “force booster” may modify force applied by the belt to a patient's chest. A compression pad, or a shock absorber, or a plunger package or a or a bladder containing a viscous or non-Newtonian fluid may be disposed between the belt and the patient's chest. The mechanism for imparting force may be a rotary motor, linear motor, solenoid or pneumatic piston. Various force-altering elements may be disposed in a drive train of the device to alter the manner in which force is applied to the patient's chest. A backboard may be provided to support the patient in a supine position and for housing various mechanical elements and mechanisms of the device. A “hybrid” device may comprise a belt and mechanism for intermittently tightening the belt, and a pneumatic tube and mechanism for intermittently pressurizing the pneumatic tube.

### FIELD

The disclosure relates to cardiac massage devices (CMDs), and to methods of operating such devices. CMDs may be used for performing external cardiac massage (ECM). Hence, the disclosure also relates to methods of performing ECM with CMDs.

### BACKGROUND

With regard to some belt-type devices such as thorax circumferences change based cardiac massage devices, as may be embodied in belt-shortening type devices and cuff-tightening based devices, it may be noted that any of these principals may use transfer of driver energy into linear motion that ultimately changes the length of material\band\strap\cuff in contact with the thorax. The reduction of amount of material extending, end-to-end from the device results in pressure applied on the thorax's circumferences, and thus for the cardiac massage. Generally, the mechanisms for applying force to the belt(s) may employ a spool (in the case of a belt) or a gear to the circumference changing element (belt, cuff). These types of force transfer are inefficient by nature as the force is not transferred to the thorax directly, but rather goes via intermediate mediums\hardware parts (like the spool) a that add friction and residual forces.

The conventional approach to the inefficiency of force-transfer (problem) is to use a powerful motor. To provide the needed energy for said motor, a strong battery is required. For example, in some devices a 2.5 kg battery may be required for 20-30 min of operation. This has some drawbacks: it may increase cost (the power source is expensive), it may make the device heavy (less portable), and it may impose larger physical dimensions on the device.

Cardiac massage refers to an intermittent compression of the heart by pressure applied over the sternum (closed, or external cardiac massage) or directly to the heart through an opening in the chest wall (open, or internal cardiac massage). Cardiac massage may be performed to reinstate and maintain blood circulation. In the main hereinafter, external (or closed) cardiac massage (ECM), and devices for performing same are discussed.

Cardiopulmonary resuscitation (CPR) is an emergency medical procedure for a victim of cardiac arrest or, in some circumstances, respiratory arrest. CPR may be performed in hospitals, or in the community by laypersons or by emergency response professionals.

CPR, when applied immediately after cardiac arrest, can often save cardiac arrest patients' lives. CPR may require that the person (caregiver, rescuer) providing chest compressions repetitively pushes down on the sternum of the patient (victim) at a rate of 80 to 100 compressions per minute. The compression of the sternum in CPR treatment is referred to as “cardiac massaging” thus, a device for “cardiac massaging” may be referred to as a “CMD”. CPR may be applied anywhere, wherever the cardiac arrest patient is stricken. Out-of-doors, away from medical facilities, it may be accomplished by either poorly (or inadequately) trained bystanders, or by highly trained paramedics and ambulance personnel.

Cardiopulmonary resuscitation (CPR) is a well-known and valuable life-saving method of first aid. CPR is used to resuscitate people who have suffered from cardiac arrest after suffering a heart attack, electric shock, chest injury and other causes for cardiac arrest or disorder. During cardiac arrest, the heart stops pumping blood, and a person suffering cardiac arrest will soon suffer brain damage from lack of blood supply to the brain. Thus, CPR requires repetitive chest compression to mechanically squeeze the heart and the thoracic cavity to pump blood through the body. CPR is usually followed by defibrillation that is intended to reset heart fibrillation. Very often, the patient is not breathing, and mouth to mouth artificial respiration or a bag valve mask is used to supply air to the lungs while the chest compression pumps blood through the body.

For many years, CPR has consisted of the combination of artificial blood circulation with artificial respiration—that is, chest compressions and lung ventilation. Recently however, the American Heart Association and the European Resuscitation Council endorsed the effectiveness of chest compressions alone—without artificial respiration—for adult victims who collapse suddenly in cardiac arrest. (Hence, in the absence of artificial respiration, “CPR” is somewhat of a misnomer, since there is no specific “P”ulmonary component.) specific effort to supplant breathing.) CPR is generally continued, usually in the presence of advanced life support, until the patient regains a heart beat (called “return of spontaneous circulation” or “ROSC”), or is declared dead.

CPR is unlikely to restart the heart, but rather its purpose is to maintain a flow of oxygenated blood to the brain and the heart, thereby delaying tissue death and extending the brief window of opportunity for a successful resuscitation without permanent brain damage. Advanced life support (most commonly defibrillation), is usually needed to restart the heart.

Traditional manual CPR usually refers to performing mouth-to-mouth rescue breathing, and performing manual chest compressions. Chest compressions may be performed by the rescuer placing the heel of his (or her) hand in the middle of the victim's chest, with the other hand on top of the first hand with fingers interlaced. Then, compressing the chest about 1½ to 2 inches (4-5 cm). Then allowing the chest to completely recoil before the next compression. Compressing the chest at a rate equal to 100/minute, and performing 30 compressions at this rate. Pausing to perform rescue breaths, then repeating chest compression followed by rescue breaths, until the victim may resume breathing or until help arrives.

Compression-only CPR, also known as cardiocerebral resuscitation (CCR), is simply chest compressions without artificial respiration. The method of delivering chest compressions remains the same as with CPR, as does the rate (100 per minute), but the rescuer delivers only the compression element which keeps the bloodflow moving without the interruption caused by mouth-to-mouth (MTM) respiration. It has been reported that the use of compression only delivery increases the chances of lay person delivering CPR.

Devices

Some devices are available in order to help facilitate rescuers in getting the chest compressions completed correctly, during delivering CPR. The simplest of these is a timing device, such as a metronome, which may assist the rescuer in getting the correct rate for chest compressions. A number of manual assist devices have been developed to help improve CPR technique. These devices may be placed on top of the victim's chest, with the rescuers hands going over the device, and may provide a display or audio feedback giving information on depth, force or rate. Alternatively, these manual assist devices may be in a wearable format such as a glove. As well as use during actual CPR on a cardiac arrest victim, which relies on the rescuer carrying the device with them, these devices can also be used as part of training programs to improve basic skills in performing correct chest compressions.

Automatic cardiac massage devices (CMDs) are also available for performing chest compressions on the victim. The chest compression device may be any device suitable for compressing the chest of a patient, such as pneumatic, hydraulic, or electric actuated pistons, belts, straps, and other.

There are a number of different types of automatic CMDs, including, for example
1. “plunger type”, having a base which goes under the patient's back, at least one upright (vertical) support members, a horizontal arm extending across the top of the device, above the patient's chest, and a mechanism including a plunger for performing compressions on the patient's chest
2. “band-type”, having a band that at least partially encircles the patient's torso, including the following variations
   a. a band encircles the patient's torso, and secures to the patient's chest a mechanism including a plunger for performing compressions on the patient's chest
   b. bands partially encircle the patient's torso, and secure to the patient's chest a mechanism including a plunger for performing compressions on the patient's chest. Distal ends of the bands are secured to a backboard which is disposed under the patient's back. Band-type “2b” is similar to band-type “2a” in that both have plunger devices, and the band essentially substitutes for the horizontal arm and support member of plunger type “1”.
   c. a band encircles the patient's torso, and a mechanism intermittently tightens (or shortens, or cinches) the band, thereby resulting in pressure applied on the thorax's circumference, resulting in cardiac massage without a plunger.
   d. a band encircles the patient's torso, and at least a top portion of the band passing over the patient's chest is hollow and can intermittently be inflated with air or a fluid, and a mechanism intermittently inserts pneumatic (air or fluid) pressure into the hollow portion of the band, thereby resulting in pressure applied on the thorax's circumference, resulting in cardiac massage without a plunger. Band-type “2d” is similar to band type “2c”.
   e. in either of band-types “2b” and “2c” (neither of which has a plunger mechanism), a substantially rigid block may be located between a portion of the band passing over the patient's chest, and the patient's chest, substantially over the patient's heart, to direct (localize, focus) pressure at the patient's heart.

Note that the plunger type and the first two mentioned band-types include a mechanism having a plunger for performing chest compressions. The “plunger” may be referred to by other names, such as “sternum compressing element”, “depressor means” , “displacement means”, and the like.

A chest compression device is known that may be fixed to the patient's chest/skin by means of fastening devices such as tape or by vacuum, or it can be merely in contact with the chest without being fastened to the chest. The chest compression device can be designed to cause the chest to expand, that is to perform an active lifting of the chest, or to allow the chest to expand freely. The chest compression device typically comprises or is connected to a support in order to maintain a substantially constant positioning of the chest compression device on the patient's chest. A substantially constant positioning of the chest compression device on the patient's chest is important in order to obtain the necessary quality of the compressions and for safety reasons.

An exemplary chest compression system (automatic CMD) may comprise a chest compression device (sternum compressing element), and a signal processor (electronic controller) connected to the chest compression device for providing control signals to the chest compression device. Measuring (sensing) devices may be provided for measuring characteristics of the resuscitation process, and the signal processor may be adapted to process input signals from the measuring devices. The measuring device(s) may be any sensors or other measuring devices suitable for measuring characteristics of the resuscitation process, and other relevant information regarding CPR in the system and/or in the patient: Such sensors/measuring devices are for example force sensors and/or depth sensors for measuring force/depth exerted/traveled by the compression device, compression counters, compression frequency counters, blood flow sensors for monitoring the blood flow of the patient, ventilation sensors for monitoring the ventilation flow, volume, and/or time interval of patient ventilation, impedance measuring means for measuring the impedance of the chest and thus give an indication of the ventilation of the patient, electrocardiogram (ECG) device, tilt sensors for measuring the angle of the patient (whether the patient is lying, sitting/standing), position detectors for detecting the positioning and/or change of positioning of the chest compression means, battery power measurement means, internal motor temperature measuring means, and the like. The results from the measuring devices may be used to provide information to the users and/or as feedback to the processor for adjusting/changing the control signals to the compression device.

In ECM, firm pressure may be exerted on the lower half of the sternum, in order to compress the heart and major vessels between the sternum and the spine, resulting in cardiac output. The pressure needed vary from about 36 kgs to 55 kgs and the sternum should be depressed about 3.5 to 5 cm, varying from patient to patient. The cycle is repeated uniformly and smoothly at about 40-100 strokes per minute, allowing approximately equal time for depression and relaxation of the sternum.

A depressor means may be adapted to be secured against the sternum of a patient and to exert pressure thereon. Contact with the sternum may be by way of a reciprocating block secured in place by support means. The support means may include a flexible band connected to the reciprocating block for fastening around the chest of a patient and sprung support legs on either side of the block for additional stability and to enhance residual pressure on the sternum. Alternatively, the support means may comprise a rigid adjustable frame.

Recently, a device names LUCAS has been made commercially available. LUCAS is a gas-driven CPR device providing automatic chest compression and active decompression. It is portable and works during transport, both on stretchers and in ambulances. See “Evaluation of LUCAS, a new device for automatic mechanical compression and active decompression resuscitation”, Elsevier, Resuscitation 55 (2002) 285-289, incorporated in its entirety by reference herein.

The Zoll® AutoPulse® Resuscitation System Model 100 is a band-type device that has its own “soft carry” stretcher (platform). Bands are strapped across the patient's chest. The device automatically adjusts the bands to the patient's chest, and performs the chest compressions. See AutoPulse® User Guide, incorporated in its entirety by reference herein. The basic operating characteristics of the device are:
compression rate 80±5 compressions per minute
compression modes (user selectable)
   30:2 (30 compressions with two 1.5 second ventilation pause
   continuous compressions
duty cycle 50±5%
compression depth 20% of chest depth, +0.25 inch, −0.5 inch

Some problems associated with manual ECM may include fatigue to the operator, variation in the rate, force and duration of compressions, and limited facility for transportation and movement of the patient while ECM is being carried out. Further, inexperienced operators often cause injuries to the patient such as fractures to the ribs and sternum, lung damage, laceration to the liver or costochondral separation.

A number of mechanical devices have been developed with a view to overcoming the problems of manual external cardiac massage. However, these devices display a number of deficiencies. For example, there may be a tendency for the sternum depressor element (or compression member) of the device to shift position on the sternum which may lead to greater instances of rib and sternal fractures, liver laceration, lung damage and costochondral separation.

The compression member of an ECM device may have a contact pad which is formed of a resiliently deformable material to spread the load applied to the patient's chest, and thereby reduce the risk of injury thereto.

Force, displacement and frequency are typical operating parameters for sternum compressing elements of ECM devices, exemplary ones of which may be:
the compression member may compress the sternum at a rate (frequency) of 80-100 compressions per minute,
the compression member may compresses (displace) the sternum a distance (depth) of 3-8 cm (30-80 mm), such as 2-5 cm (20-50 mm), or 4-5 cm (40-50 mm)
the compression member may exert a force of 10-64 kg on the sternum

Note that force is substantially related to displacement, depending on, for example, the elasticity of the medium being acted upon.

As reported in “Compression force-depth relationship during out-of-hospital cardiopulmonary resuscitation”, Elsevier, Resuscitation (2007) 72, 364-370, incorporated in its entirety by reference herein, for chest compressions to be efficient, they must be executed with a force sufficient to produce adequate sternal displacement, and there may be a strong non-linear relationship between the force of compression and the depth achieved. The difficulty of an adult rescuer providing chest compressions with the force necessary to displace the sternum to an adequate dept is discussed. The elastic properties of the human chest during chest compressions, and the force the force needed to induce a given depth of sternal deflection is discussed. Variations in chest wall elasticity between individuals is discussed, as well as how chest elasticity may change over time

Resuscitation systems are known, for example, comprising a chest compression device to repeatedly compress the chest of a patient and thereafter causing or allowing the chest to expand, a defibrillator to apply electric impulses to the heart, measuring devices for measuring characteristics of the resuscitation process, and a signal processor for controlling operation of the chest compression device and/or the defibrillator. The defibrillator may be an integrated or external device working in a master/slave relationship with the remaining system. The defibrillator may be controlled by predetermined characteristics of the resuscitation process, which may include predetermined and/or measured characteristics.

Band-Type External Cardiac Massage (ECM) devices are known wherein pressure is transmitted from the pressure source to the sternum via a depressor means in a rhythmic fashion gradually increasing over time to a maximum, then decreasing at a like rate while maintaining a minimum residual pressure on the sternum. Pressure may be transmitted from said pressure source to the sternum in a cyclic fashion gradually increasing over time in the first half of a cycle to a maximum pressure and decreasing at a like rate over the second half of a cycle. The pressure may not decrease to zero, a minimum residual pressure may be maintained. This may result in an effective compression of the heart with minimum risk of physical injury to a patient.

Plunger-type External Cardiac Massage (ECM) devices are known wherein an adjustable time controls the operation of the displacement means, for a fixed rate, such as 20 compressions per minute.

Plunger-type External Cardiac Massage (ECM), high impulse CPR devices are known wherein a waveform (associated with movement of the plunger) more closely resembles a square wave, or impulse, rather than a sinusoidal form. This may result in a fast rise in the chest compression stroke, and consequently applying a greater amount of energy to the patient during the systolic phase, which may improved perfusion in the cardiovascular system of the patient.

Various external cardiac massage (ECM) devices are known, such as (but not limited to), for example:
a device including piston that is placed over the chest cavity and supported by an arrangement of beams. The piston is placed over the sternum of a patient and set to repeatedly push downward on the chest under pneumatic power. The patient must first be placed within the device, and the height and stroke length of the piston must be adjusted for the patient before use, which may lead to delayed chest compression.
a device for hand operated action on the sternum. The device is composed of a simple chest pad mounted on a pivoting arm supported over a patient, which can be used to compress the chest by pushing down on the pivoting arm. This device, as well as other hand operated chest compressing devises, are not clinically more successful than manual chest compression (see Taylor, et al.: External Cardiac Compression, A Randomized Comparison of Mechanical and Manual Techniques, 240 JAMA 644 (August 1978), incorporated in its entirety by reference herein).
Other devices for mechanical compression of the chest include a compressing piston that is secured in place over the sternum via vests or straps around the chest. The device may be powered by an air cylinder. An external cardiac massage device may be manually operated.
a vest or belt designed for placement around the chest may be provided with pneumatic bladders that are filled to exert compressive forces on the chest.

A response to cardiac arrest generally comprises four phases:
by bystander CPR,
Basic Cardiac Life Support (BCLS),
Advanced Cardiac Life Support (ACLS), and
Emergency Room procedures.

Bystander CPR occurs, if at all, within the first few minutes after cardiac arrest. Basic Cardiac Life Support (BCLS) may be provided by first responders who arrive on scene, in average 10 minutes after being dispatched to the scene. First responders include ambulance personnel emergency medical technicians, firemen and police. Though defibrillation and drug therapy is often successful in reviving and sustaining the patient, CPR is often ineffective even when performed by well-trained first responders and ACLS personnel because chest compression becomes ineffective when the providers become fatigued due to the difficulty to maintain the rate and compressions force for longer than few minutes. Thus, the initiation of an effective and continuous CPR before arrival of first responders is critical to successful resuscitation. Moreover, the assistance of an automatic mechanical chest compression device during the BCLS and ACLS stages is needed to perform and maintain a continuous and effective resuscitation.

### SUMMARY

This summary section of the patent application is intended to provide an overview of the subject matter disclosed herein, in a form lengthier than an “abstract”, and should not be construed as limiting the disclosure to any features described in this summary section.

It may be an object of the disclosure to provide improved techniques for performing external cardiac massage (ECM), using cardiac massage devices (CMDs). This may include the devices, features of such devices, systems incorporating such devices, and methods of operating the devices.

It may be an object of the disclosure to provide a cardiac-massage-device (CMD) that is compact, light weight and portable, is efficient in providing external cardiac compressions, easy to operate and simple to store, carry along and transport in public as well as domestic premises.

It may be an object of the disclosure to provide a cardiac-massage-device (CMD) that can be adjusted to the physiological parameters of any individual and a plunger that applies the required force and depth of compressions suitable to the specific elasticity of any given patient's thorax.

It may be an object of the invention to improve the structure and operation of belt-type ECM devices.

It may be an object of the invention to modify and/or augment force delivered by belt-type ECM devices.

It may be an object of the invention to improving or optimizing force delivery in thorax circumferences change based cardiac massage devices, as may be embodied in belt-shortening type devices and cuff-tightening based devices.

According to an embodiment of the disclosure, an external cardiac massage (ECM) device may comprise: a sternum compressing element adapted to be positioned on a patient's chest for massaging the patient's heart; a mechanism for imparting force to the sternum compressing element; and a force booster, operatively disposed between the mechanism for imparting force and the sternum compressing element. The force booster may comprise a compression-type spring, and the spring may be pre-compressed. One or more force modifying elements may be disposed in a drive train from the mechanism for imparting force to the sternum compressing element. The force booster may comprise an energy-accumulation mechanism. The force booster may comprise a force-modifying element. A force-modifying element may be adapted to be used in conjunction with the force-boosting element. The device may further comprise an electronic controller for controlling movement of the sternum compressing element. The sternum compressing element may comprise a compression band adapted to at least partially encircles a patient's torso. The device may further comprise a block of material adapted to be portion of the compression band passing over the patient's chest, and the patient's chest, and the block of material may comprise a compression pad, or a viscous fluid, or a non-Newtonian fluid. The mechanism for imparting force may be selected from the group consisting of rotary motor, linear motor, solenoid, and pneumatic piston.

The ECM device may further comprise: a backboard adapted to support the patient in a supine position and for housing various mechanical elements and mechanisms of the device.

The sternum compressing element may comprise a belt. A force-altering element may be disposed between a portion of the belt passing over the patient's chest and the patient' chest.

The force-altering element may comprise a shock absorber. The force-altering element may be is adapted to dampen force in at least one direction. The force-altering element may be adapted to store energy in at least one direction. The device may further comprise a drive spindle for intermittently tightening the belt. A torsion spring may be disposed on the drive spindle. At least a portion of the belt may comprise a pneumatic tube portion. The mechanism for imparting force may comprise a pump providing pressurized air or fluid to a pneumatic portion of the belt. The device may further comprise a force-modifying element disposed in fluid communication between the pump and the pneumatic portion of the belt, and said force-modifying element may be selected from the group consisting of valves, petcocks, and dampers.

According to an embodiment of the disclosure, an external cardiac massage (ECM) device may comprise: a belt or cuff at least partially encircling a patient's chest: a mechanism for in intermittently tightening the belt; a plunger package disposed between the belt and the patient's chest, said plunger package comprising at least one of: a second mechanism for imparting force to the plunger; a plunger acted upon by the second mechanism for imparting force; and a position/angle altering mechanism adapted to alter a direction or position of force applied by the plunger to the patient's chest.

According to an embodiment of the disclosure, an external cardiac massage (ECM) device may comprise: a belt or cuff at least partially encircling a patient's chest: a mechanism for in intermittently tightening the belt or cuff; a pneumatic tube disposed between the belt and the patient's chest; and a mechanism for intermittently pressurizing the pneumatic tube.

According to an embodiment of the disclosure, an external cardiac massage (ECM) device may comprise: a sternum compressing element adapted to be positioned over a patient's thorax for externally massaging the patient's heart; a mechanism for imparting force to the sternum compressing element; a controller for controlling movement of the sternum compressing element; and memory to record and retain a coherent (usually time-based) record (data) of device operation and patient condition. The memory may be selected from the group consisting of disk, Flash Memory and compact disc (CD). The following terms may be used in the descriptions set forth herein:
oxygen saturation In medicine, oxygen saturation (SO2), commonly abbreviated as “sats”, measures the percentage of hemoglobin binding sites in the bloodstream occupied by oxygen. At low partial pressures of oxygen, most hemoglobin is deoxygenated. At around 90% (the value varies according to the clinical context) oxygen saturation increases according to an oxygen-hemoglobin dissociation curve and approaches 100% at partial oxygen pressures of >10 kPa. A pulse oximeter relies on the light absorption characteristics of saturated hemoglobin to give an indication of oxygen saturation. An SaO2 (arterial oxygen saturation) value below 90% is termed hypoxemia. This may be due to various medical conditions.
pulse oximeter A pulse oximeter is a medical device that indirectly measures the oxygen saturation of a patient's blood (as opposed to measuring oxygen saturation directly through a blood sample) and changes in blood volume in the skin, producing a photoplethysmograph. A pulse oximeter is a particularly convenient noninvasive measurement instrument. Typically it has a pair of small light-emitting diodes (LEDs) facing a photodiode through a translucent part of the patient's body, usually a fingertip or an earlobe. Measuring oxygen saturation may be referred to as “oximetry”.
sternum The sternum (commonly referred to as breastbone) is a long flat bone located in the center of the thorax (chest). It connects to the rib bones via cartilage, forming the rib cage with them, and thus helps to protect the lungs, heart and major blood vessels from physical trauma.
thorax The thorax is a region of a body that is located between the head and the abdomen. The thorax is formed by the sternum, the thoracic vertebrae and the ribs. It extends from the neck to the diaphragm, and does not include the upper limbs. The heart and the lungs reside in the thoracic cavity, as well as many blood vessels. The inner organs (such as the heart) are protected by the rib cage and the sternum. The term soft tissue refers to tissues that connect, support, or surround other structures and organs (such as the heart) of the body. Soft tissue includes tendons, ligaments, fascia, fibrous tissues, fat, and synovial membranes (which are connective tissue), and muscles, nerves and blood vessels (which are not connective tissue).

### BRIEF DESCRIPTION OF FIGURES

Examples illustrative of embodiments of the disclosure are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures (FIGs.) are listed below.

Many of the figures presented are in the form of schematic illustrations and, as such, certain elements may be drawn greatly simplified or not-to-scale, for illustrative clarity. The figures are not intended to be production drawings.

FIG. 1A schematically shows an embodiment of a cardiac-massage-device (CMD).

FIG. 1B schematically shows the CMD illustrated in FIG. 1A viewed from the rear with defibrillation pads connected that enable it to function also as a defibrillator.

FIG. 2 schematically shows an embodiment of a CMD, having springs connected to the plunger driving mechanism.

FIG. 3A schematically shows an embodiment of a full-circle plunger driving wheel mechanism of a CMD.

FIG. 3B schematically shows an embodiment of an arc-motion plunger driving wheel mechanism of a CMD.

FIG. 4 schematically shows the CMD illustrated in FIG. 1A positioned over the chest of a lying patient for commencing external cardiac massage (ECM).

FIG. 5 is a block diagram of the controls of a CMD in accordance with embodiments of the present invention.

FIG. 6A schematically shows a cross-sectional type view of an embodiment of a cardiac-massage-device (CMD).

FIG. 6B schematically shows a cross-sectional type view of an embodiment of a cardiac-massage-device (CMD).

FIG. 7A schematically shows a cross-sectional type view of an embodiment of a cardiac-massage-device (CMD).

FIG. 7B schematically shows a cross-sectional type view of an embodiment of a cardiac-massage-device (CMD).

FIG. 8A schematically shows a cross-sectional type view of an embodiment of a cardiac-massage-device (CMD).

FIG. 8B schematically shows a cross-sectional type view of an embodiment of a cardiac-massage-device (CMD).

FIG. 8C schematically shows (partially) a cross-sectional type view of an embodiment of a cardiac-massage-device (CMD).

FIG. 9A schematically shows a cross-sectional type view of an embodiment of a cardiac-massage-device (CMD).

FIG. 9B schematically shows (partially) a cross-sectional type view of an embodiment of a cardiac-massage-device (CMD).

FIG. 9C schematically shows (partially) a cross-sectional type view of an embodiment of a cardiac-massage-device (CMD).

FIG. 9D schematically shows (partially) a cross-sectional type view of an embodiment of a cardiac-massage-device (CMD).

FIG. 10 schematically shows a cross-sectional type view of an embodiment of a cardiac-massage-device (CMD).

FIG. 11 schematically shows (partially) a cross-sectional type view of an embodiment of a cardiac-massage-device (CMD).

### DETAILED DESCRIPTION OF EMBODIMENTS

In the following description, various aspects of techniques for external cardiac massage (ECM) will be described. For the purpose of explanation, specific configurations and details are set forth in order to provide a thorough understanding of the techniques. However, it will also be apparent to one skilled in the art that the techniques may be practiced without specific details being presented herein. Furthermore, well-known features may be omitted or simplified in order not to obscure the description(s) of the techniques.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples, methods and materials presented in the in the description, as well as in the claims, should not be construed as limiting, but rather as illustrative.

Terms for indicating relative direction or location, such as “up” and “down”, “top” and “bottom”, “horizontal” and “vertical”, “higher” and “lower”, and the like, may also be used, without limitation.

An Example of a Cardiac Massage Device (CMD)

Generally, a cardiac massage device (CMD) may comprise a cardiac massaging element for providing controlled compression of a thorax of a patient; and a controller for controlling the compression based on characteristics of the patient.

The CMD may comprise some or all of the following elements:
a driver, which may comprise an electrical motor;
a plunger coupled to a driver for driving the plunger;
a structure having first element adapted to be at least partially inserted below a back of a patient, and a second element adapted to position the plunger over the thorax of the patient to perform external cardiac massage (ECM). The structure may be collapsible (foldable), and at least one element of the structure may be length-adjustable, for fitting the structure to a patient when deployed (unfolded); and
a controller adapted to monitor a compression force applied by the plunger on the thorax of the patient, and vary the compression force, depth and/or frequency (rate of compressions);

The structure may comprise a strain release mechanism for unloading overload applied by the plunger on the thorax of the patient.

The CMD may comprise a sensor for determining the elasticity of the thorax of the patient, and the controller may be adapted for adjusting the operation of the driver of the plunger or adjusting the travel of the plunger, to comply with the elasticity of the thorax of the patient.

The CMD may comprise one or more sensors, selected from a group of sensors comprising: compression sensors, load sensors, strain sensors, pulse sensors, blood pressure sensors, ECG sensors, CO2 sensors and oximetry sensors.

The plunger may comprise at least one energy storing element, which may comprise at least one preloaded spring.

The CMD may comprise a microphone, and a speaker for providing audible guidance to a caregiver.

The CMD may comprise a communication module for communication with a remote location.

The CMD may comprise a memory for storing and retrieving operation data of the device.

The CMD may comprise a defibrillator. The CMD may be adapted to communicate with a separate cardiac defibrillator.

The weight of the CMD may be no more than 3 kilograms and, in a compact (folded, not deployed) state, the CMD may have a volume of no more than one thousand cubic centimeters.

Generally, a compact, light weight (such as less than 5 kg) and portable automatic mechanical CMD is provided. When a situation arises in which a person is in cardiac arrest the device may be deployed, and used. First, a preliminary deployment of the device may be done, followed by a personal fitting of the device to the patient. Thus, the device is fitted and affixed to the patient by a caregiver (the operator of the device, or “rescuer”). Upon being affixed to the patient the device operation may be initiated by the caregiver. The device is simple and quick to adjust to the anatomical build of a patient in need of CPR and is simple to operate by people who may have had no previous experience.

The CMD may comprise a rigid or a semi-rigid foldable structure that is adapted to transform from a folded state to a deployed state. In its folded state, the device is compact for storage and easy to carry along. The folded device may be pocket-sized, and may be suitable to be carried in a pocket or on the waist belt of a caregiver.

The CMD may be further adapted to facilitate a size adaptation of its structure in its deployed state to the anatomical build of the patient. Such adaptation may be performed in various ways. For example, the device's structure may comprise longitudinally extendable elements that are capable to extend or to be minimized, such as but not necessarily telescopic rods that allow the caregiver to fit the device size in a deployed state to a specific patient.

The CMD may be mounted on the patient from his (or her) left-hand or right hand side. Or, the CMD may be mounted on the patient from the shoulders downward towards the thorax.

The CMD may be partially or fully dismantled for compact storage, and may be assembled upon use.

The CMD may include a mechanical plunger driven by a motor such as an electric power-packed motor (with one or more batteries serving as its power source), optionally, with a planetary gear. The motor may be a DC (direct current) motor, and may be integrated in the device structure.

The motor may be of a small size and light weight. A small size and light weight motor is typically characterized by a lower torque. Since a motor force is calculated as: force=torque×rpm (round per minute), the initiation of an exemplary 50kg force for providing effective CPR, a high rpm (revolutions per minute) motor may be used in order to compensate for the lower torque. Thus, the motor may be a high speed motor with at least 10,000 rpm.

The plunger (“sternum compressing element”) is driven by the motor (“mechanism for imparting force”), to thereby perform cardiopulmonary chest compressions. The motor may forces the plunger, via a crankshaft, to move in a repetitive predetermined vertical travel course of compression and release of the thorax. The motion is between two opposite positions of the plunger may be in a range of 3 to 8 cm. In order to compress the thorax approximately 3 to 8 cm deep (which is typically the desired compression depth) an approximate typical force load of approximately 50 kg on the thorax may be required.

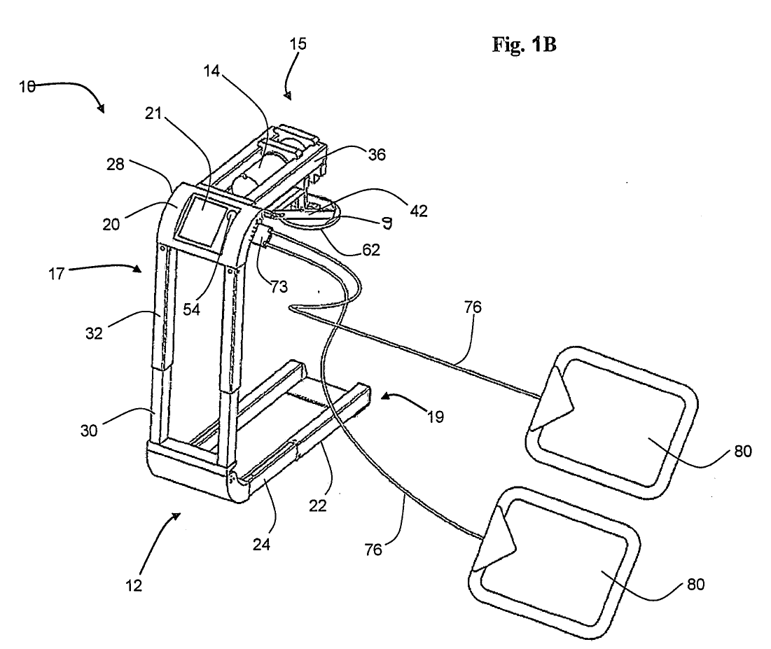

In order to be able to extract the required force (such as 50 kg) for compression, using a compact motor, an energy storing element such as preloaded spring (or springs), a memory flex material, pneumatic or hydraulic piston that is adapted to function as a spring, or any other energy storing material known in the art that is suitable for the purposes of the present invention, is used to assist the motor in forcing the plunger movement (illustrated in FIG. 2). The energy storing element may be connected to different parts of the device such as the plunger, the crank, the motor, the structure and any other part of the device that is related to the compression/release mechanism. For example, a pre-loaded spring may be connected to the plunger itself or to the plunger mechanism to apply constant force on the plunger in the same direction as the motor does. In such an configuration, the spring may be acting as an energy storing element, and thus, the spring load is added to the motor force load on the plunger and the accumulated force of the motor and spring may be applied to the patient's thorax. With the aid of the spring (or springs), the force-load required from the motor may be substantially reduced, enabling the use of a smaller, lighter and less expensive motor, while also utilizing lower power supply consumption of the batteries used to operate the motor.

The device may comprise a control unit that controls the motor and thus the motions of the plunger. The control unit may comprise an electronic controller and control circuitry adapted to monitor and govern the rate of compression/release cycles, the compression force and any other relevant parameter to the performance of the CPR procedure. For example, information concerning the plunger's motion may be obtained from sensors connected to the plunger mechanism or to the structure (hereinafter: “compression indication sensors”). The compression indication sensors may be adapted to provide indications regarding the plunger motion or the load applied by the plunger. Said indications may be used to monitor and control the compression load on the patient's thorax. Alternately, said indication may be retrieved from an encoder (sensor) incorporated in the motor.

The CMD of the present invention may further comprise a “life-signs” sensor or sensors, for example a pulse sensor, an ECG monitoring module and/or blood pressure, a CO2 sensor and an oximetry sensor. The controller may process data fed to the controller from said “life-signs” sensors applied to a CPR patient, and direct commands to the driving mechanism to initiate the automated CPR or advise the caregiver to initiate CPR.

The term “plunger driving mechanism” may be used herein to refer to the mechanical mechanism that enables the motion and stability of motion of the plunger.

The control unit may be further adapted to operate a man-machine interface. The man-machine interface may comprise at least an operation “ON”/“OFF ” button, an LCD (liquid crystal display) panel, or an LED display, a speaker for audio feedback or guidance and a microphone. For example, the speaker and microphone may be used by an untrained caregiver to communicate with medical professionals to thereby assist the caregiver in dealing with a cardiac arrest case. The microphone may also be used for recording scene ambient sounds for documenting the process of CPR events.

The control unit may be further adapted to govern the device state, for example battery state, load on the motor, pre-tensioning of the plunger against the patient's thorax, state of a communication link with a remote location and the adequate deployment of the device.

The CMD may also include a memory for storing data relating to the operation of the device or data relating to the patient. This data may include, for example, data concerning the motor operation, the plunger travel, the plunger load on the patient's thorax, the device state, pulse rate of the patient, blood pressure of the patient, and other data.

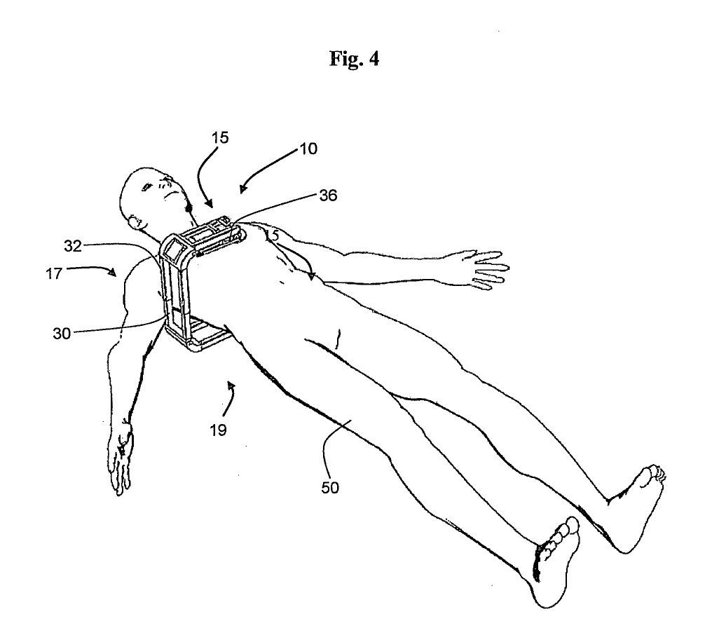

When performing a CPR procedure, the CMD may perform one or more of the following exemplary actions (through control unit commands):
apply compressions at a predetermined rate and force or depth (generally, force is related to depth, and to the elasticity of the medium being acted upon);
sense the pre-tension of the plunger against the thorax using a sensor such as but not limited to, a pressure sensor;
count the number of compressions and compares the count to a target number of compressions per cardiac massage cycle;
monitor the patient's blood circulation to determine necessity and effectiveness of the cardiac massage;
establish and manage a communication link with an automated external defibrillator (AED), either integrated in the CMD or separated therefrom, to effect synchronized performance of CPR and defibrillation (see defibrillation module and pads, elements 78 and 71, respectively, in FIG. 5);
send and receive data from a remote location such a cardiac monitoring service center (designated 64 in FIG. 5) using a communication module;
upload or download data from or to the controller; and/or
provide audio and or visual guidance to the caregiver.

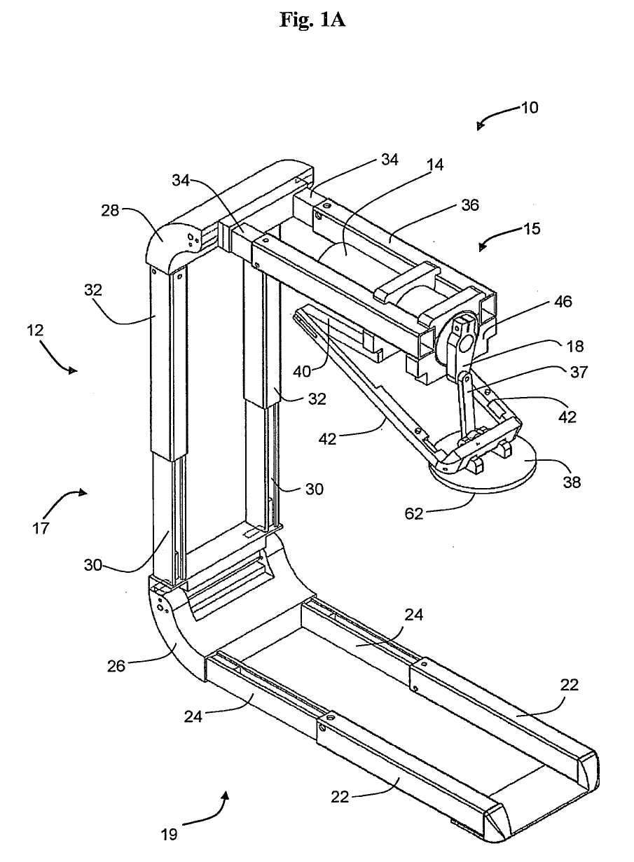

An exemplary plunger type CMD will now be described, in greater detail, with respect to FIGS. 1A-5.

FIG. 1A is an isometric illustration of a three-part support-structured CMD 10, viewed from the front. FIG. 1B illustrates an isometric view of CMD 10 from the rear having defibrillation pads 80 (see 71, FIG. 5) connected to the device via cords 76. Adaptor 73 bridges the connection between the cords and device 10.

CMD 10 may be constructed of: a foldable and rigid support-structure 12, an electric motor 14 incorporated into support-structure 12 and a plate-plunger 38 connected to motor 14 by a driving mechanism such as a crankshaft 18. Optionally, one or more lifesigns sensors (not shown) are connected to a control unit 20 which is built into or integrated with, support-structure 12.

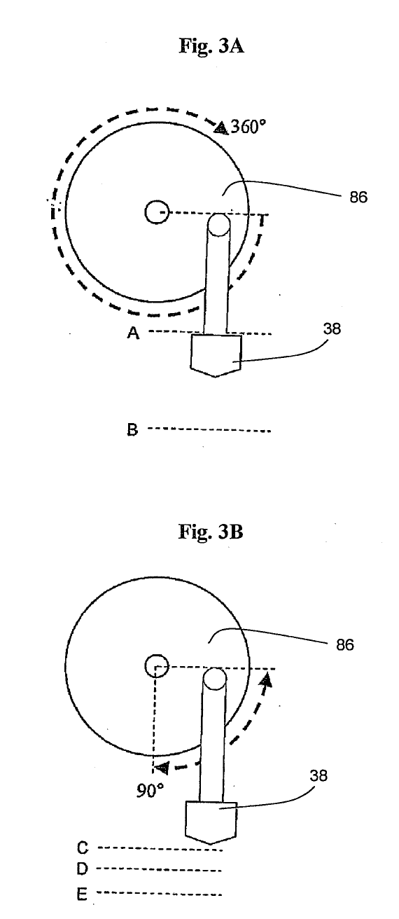

The support-structure 12 may be composed of three elements: a length adjustable base-element 19, a height-adjustable-element 17 and a length-adjustable plunger-carrying element 15. Each of the three elements may be composed of two two-parallel-bars-units bridged at their end by a perpendicular bar (each unit referred from herein after as “TPBU”), made of light yet strong and rigid material or materials such as aluminum, titanium, sturdy plastics, composite materials and the like. By sliding one of the TPBU over the other TPBU a desired length of each of the three elements of supporting structure 12 may be determined. A suitable latching mechanism (not shown) may enable reversible adjustments and fixing-in-place desired lengths of the three elements of support structure 12 in accordance with the anatomical build of a CPR treated person as demonstrated in FIG. 4. One or more of the TPBUs may be extracted automatically to a predetermined state, for example, by virtue of a mechanical guidance or spring load that forces the TPBU to extract to a predetermined position upon deployment of the device. The automatic positioning of the TPBU may assist the caregiver in deploying the device.

The plunger 38 may be, for example, a 10 cm in diameter circular plate made of a substantially rigid material and covered by a soft, cushioning and biocompatible material, so as minimize harming the treated CPR patient. The plunger 38 can also be constructed in various shapes (not necessarily round) and have various diameters. The plunger 38 may be formed as an integral part of the crankshaft 18 or connected directly to crankshaft.

When the device 10 is in a deployed state, height-adjustment-element 17 is connected at one end at an angle (typically, but not limited to, 90 degrees) to base element 19 and at the other end to plunger-carrying-element 15 in an angle that positions element 15 in parallel to element 19. When in a deployed state, the base-element 19 is typically stretched (“length adjusted”), the length of element 17 may be adjusted to the anatomical build of the CPR patient (shown in FIG. 4) and the length of element 15 may be adjusted so as to be at the center of the thorax of the CPR patient (shown in FIG. 4). The connection-angles between the three elements of supporting structure 12 can be varied and fixed in place to the hinge-units (26 and 28). The fixing in place at an angle of choice may be done by a locking-mechanism based on reversibly inserted pins that run through several possibilities of aligned-holes between the end of the elements of support-structure 12 and the two hinge-units.

The three elements of supporting structure 12 are typically connected with one another when device 10 is in either a folded or deployed state. When in a folded state the three elements may be positioned substantially in parallel. Optionally, the elements may be designed so as to be disconnected from one another for the storage and maintenance of device 10.

The length-adjustable base element 19 may be made of a TPBU 22 that slides over fixed-in-place TPBU 24 (enabling the “stretching” of the element). TPBU 24 may be pivotally connected to hinge-unit 26. Hinge-unit 26 may be connected to another hinge-unit 28 by a height adjustable mechanism comprising fixed-in-place TPBU 30 that has a TPBU 32 sliding over it. Alternatively, TPBU 30 may be fixed-in-place and having TPBU 32 fit into TPBU 30, thus having TPBU 30 slide over TPBU 32. TPBU 30 and TPBU 32 together with hinge-units 26 and 28 may comprise height-adjustable element 17. Hinge-unit 28 may pivotally connect to a suspended element comprising TPBU 34 that has TPBU 36 sliding over it. Alternatively, TPBU 34 may slide over TPBU 36.

The electric motor 14 may be positioned between the bars of TPBU 36. At the end of TPBU 36, distanced from hinge-unit 28, the motor 14 is connected and has a rotational crankshaft 18 pivotally connected to plunger 38 by bar 37. A bridging plate 46 connects between bars of TPBU 36 and surrounds the motor 14, thereby stabilizing it in place.

The downward-facing side of plunger 38 may be provided with a pressure (“compression”) or load-sensor 62. The sensor 62 may measure and transmit data of the load of the plunger against the patient's thorax to the control unit 20. Load sensor 62 may be disposed in alternate locations of the CMD, for example, yet not limited to, arms 42, bar 37, TPBU 30 or other locations, either directly or indirectly, representing the load of the plunger on the thorax.

Plunger 38 may be connected to two parallel arms 42 which are connected to a base-plate 40. The plunger 38 may be connected to plunger carrying element 15 directly.

Base-plate 40 may be connected to bars 36, to stabilize the motor 14 in place. When the crankshaft 18 is rotated by the motor 14, the plunger 38 may linearly and vertically oscillate in a fixed course, causing a cyclic compression and releasing effect of the plunger on the patient's thorax. TPBU 34 and TPBU 36 together with hinge unit 28 and bridging-plate 46 comprise plunger-carrying element 15.

Hinge-units 26 and 28 enable the folding of TPBUs 22 and 24, and TPBUs 34 and 36 towards TPBUs 30 and 32, respectively.

As best viewed in FIG. 1B, the control unit 20 may be integrated into the structure of the hinge-unit 28. Alternatively, the control unit 20 may be connected to hinge unit 26 or be part of any other component of the CMD that is adapted to house the control unit. The control unit 20 may also include an “ON”/“OFF” button 54, an LCD display 21 (can also be a LED), a speaker (not shown) for audio feedback or guidance and a microphone (not shown).

Optionally, pads 80 may be provided for attachment to the CPR treated person for measuring physiological parameters such as pulse or blood pressure. The data may be transmitted from the pads 80 via cords 76 and adaptor 73 to the control unit 20 for processing and commanding the activity of the plunger.

FIG. 2 illustrates the CMD 75 in a fully deployed state, and the plunger driving mechanism of the CMD 75 will now be described.

A plunger driving mechanism may utilize an energy-storing (accumulating) mechanism 44 to assist the motor in driving the plunger while applying compressions to the patient's thorax (or chest). In FIG. 2, these energy-storing elements are illustrated as being located between the arms 42 and the plate 46. The energy-storing (accumulating) mechanism 44 may comprise any number of mechanical elements (such as linkages, levers, dashpots, cams, eccentrics, over-center mechanisms, resilient elements, and the like) capable of, for example, storing energy during a portion of the up or down-stroke of the plunger, and releasing the stored energy during another portion of the down or up stroke of the plunger. These mechanical elements are typically “passive” in that they do not have their own energy source.

For example, during the upstroke energy from the motor is stored, and during the downstroke, which is the chest compression stroke, the plunger benefits from the force supplied by the motor as augmented by the stored-up force supplied by the energy-accumulating elements.

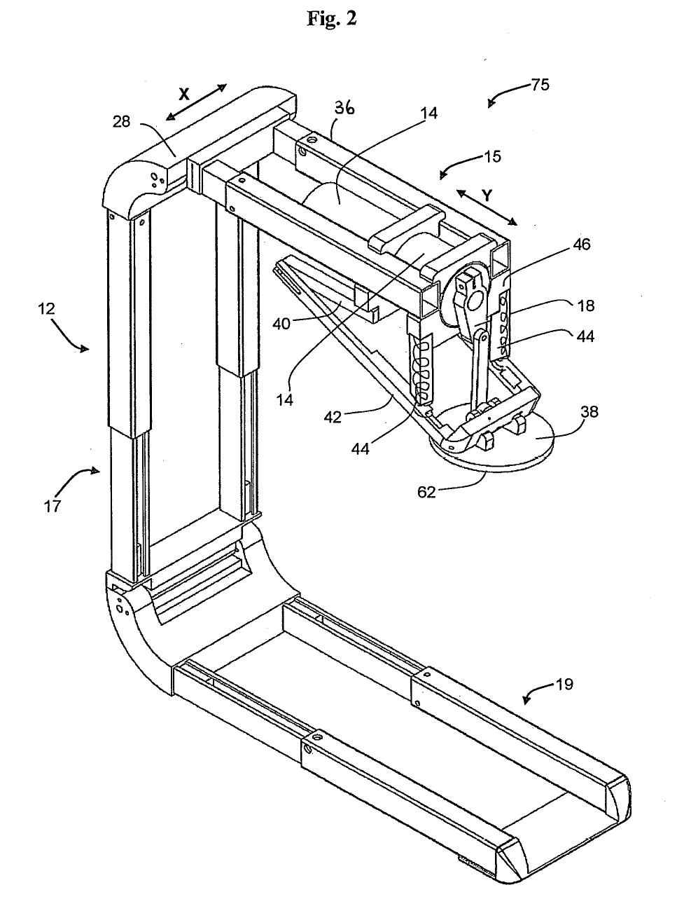

Or, for example, the energy-accumulating elements 44 may comprise springs which are positioned vertically and connect between arms 42 and plate 46. The springs 44 may be made of material that maintains its resilience after many repeats of being compressed and relaxed. The arms 42 may be pivotally connected at one end to plate 40 and at the other end to plunger 38. The rotation of crankshaft 18 by the motor 14 drives plunger 38 in a fixed linear and vertically oscillation course (further illustrated in FIG. 3A). When the plunger 38 is drawn towards plate 46, the springs 44 may be compressed. When the direction is reversed, the springs 44 may expand adding the stored energy to the force of motor 14.

Variations on the above may include:
the structure elements description of the embodiments described herein may be replaced with solid or flat surface elements rather then telescopic rods.
the force retaining elements description of the embodiments and attached Figures set forth in this specification may be replaced with members made of memory flex materials or pneumatic or hydraulic operated mechanisms.

FIG. 3A illustrates an embodiment of a full-circle plunger driving wheel mechanism of which an embodiment is illustrated in FIGS. 1A and 2 (rotation of crankshaft 18 by motor 14). In this embodiment, a “full-circle” plunger driving wheel 86 may turn a full rotation of 360 degrees and thus, the plunger 38 may compress the chest of a CPR patient within predetermined boundaries, designated “A” and “B” in the figure.

FIG. 3B illustrates an embodiment for the driving mechanism of plunger 38, consisting of an “arc-motion” plunger driving wheel mechanism. The use of 90 degree arc-motion plunger driving wheel 86 that can rotate in both directions in accordance with the motor's motion direction, as illustrated in the figure, enables rotating the driving wheel in an arc that is less than the full 90 degrees rotation, thereby enabling a variable and incremental adjustment of the distance traveled by the plunger. By not being restricted to rotating the full 90 degrees, the plunger does not necessarily reach the limit of the predetermined course boundaries, designated A and C. In an embodiment of the driving mechanism of plunger 38, the plunger is brought down to the chest of a CPR patient so it is traveling a fixed distance of approximately 1 cm, designated D in the figure.

A compression-sensor in the plunger (designated 62 in FIGS. 1A and 2) measures the encountered resistance on-contact with the chest of the patient and relays the information to a controller (designated 20 in FIG. 5). The controller 20 processes the information and may command the motor 14 to change the traveling distance of the plunger by changing the rotating-angle of the driving wheel 86. With additional contacts between the plunger and the chest of the patient, the optimum traveling distance of the plunger may be determined. The plunger-motor feed-back mechanism enables the fine tuning of the compression of the plunger to be adjusted to the anatomical build of the treated patient. In this manner, specific adaptation of the compressions to the anatomical build of each specific patient may be provided to thereby improve the safety of the CPR procedure by avoiding over-compression on the patient's thorax that may lead to undesired fractures of the ribs and physical damage to the patient.

In FIG. 3B, three exemplary boundaries of the motion of the plunger (of the very many possibilities) are designated C, D and E. By using a sensor or sensors on plunger 38 (designated 62 in FIGS. 1A and 2) the plunger may be initially operated on the treated CPR patient in a slow and delicate motion to obtain information regarding the optimal compression distance and force that is to be used. At least one sensor may be located in a variety of locations in the CMD 10, including but not limited to the plunger 38, the crankshaft elements 18 or 37, plunger carrying element 15, height adjustable element 17 and on hinge-units 26 or 28. The information from the at least one sensor may be processed, and the motor 14 may be instructed to rotate the arc-motion plunger driving wheel 86 in a suitable angle and force. In accordance with embodiments of the present invention the at least one sensor may comprise a load sensor or a strain-gauge sensor, and the optimal compression distance and force may be determined according to information obtained from the sensor from at least one compression on the patient's thorax. In a specific embodiment, the information may be compiled from a sequence of compressions, wherein each compression differs from the other compressions either by the travel of the plunger, the force of the motor or both.

Adjustment of the travel of the plunger to the elasticity of the patient's thorax may be obtained by deriving information regarding said elasticity from the load on the motor 14. Said load may be obtained by measuring the power consumption of power source 56 (shown in FIG. 5), wherein a correlation between the thorax elasticity and the load on the motor may be established.

At least one sensor may be used to monitor the load on the patient's thorax. When reaching a threshold value that may reflect a risk of an overload to the patient's thorax a safety mechanism may be initiated. An exemplary safety mechanism may be established by electronic means to thereby halt the operation of the motor and thereby to decease the compressions on the patient's thorax. An alternate safety mechanism may be established by incorporating in the CMD 10 a mechanical strain relief element that is adapted to mechanically release an overload. Such an element may be any mechanical strain relief element or mechanism that is known in the art.

FIG. 4 illustrates the CMD 10 deployed with its plunger 38 disposed over the chest of a supine (lying on the back) patient 50 for commencing CPR treatment. The length-adjustable base 19 is shown positioned under the back of patient 50 and TPBUs 30 and 32 are shown slid so as to fit the device deployment to the anatomical build of patient 50. Plunger carrying element 15 may be positioned at the center of the thorax of patient 50 by adjusting the position of plunger 38 with respect to the center of the thorax by sliding TPBUs 36 over 34 (TPBU 34 is not visible in this figure).

FIG. 5 illustrates a block diagram of an embodiment of the CMD 10 shown in FIG. 1A. The control of CMD 10 may be done through a control unit 20 which may be constructed of a controller and a control circuitry. Control unit 20 may obtain power from DC (direct current) power source 56, and may be provided with an “ON/OFF” power button (switch) 54. Sensor 62 (senses “compression” or “load” on the plunger) transmits data to control unit 20. In addition, data signals may be transmitted or received from a data communication module 64 from/to an external device (not shown), for example CPR-event data downloading or programming the controller 20.

Upon initiation of operation of the CMD 10, the controller 20 causes module 66 to provide activation/deactivation commands 66 to the motor 14, setting into motion or stopping the motion of plunger 38.

Optionally an LCD or an LED display 21, a speaker 68 for audio feedback or guidance and a microphone 70 are connected to control unit 20.

The control unit 20 may obtain information regarding the status of device 10, such as the battery state, the load on the motor, the pre-tensioning of the plunger against the patent's thorax and the adequate deployment of the device, and provides indication via STATUS INDICATOR 72. Said indications may be provided via DISPLAY 21.

The control unit 20 may be adapted to monitor and govern the rate of compressions, the compression/release cycle and any other parameter relevant to the performance of the CPR. Optionally data from “life signs” sensors (not shown in the figure) may be processed in controller 20, which may then activate an electronic defibrillation module 78 that actives, in turn, defibrillation pads 71 (FIG. 5).

A Dynamically-Controlled Automatic External Cardiac Massage (ECM) Device

A Cardiac Massage Device (CMD) has been described hereinabove, and discloses:
automatic height adjustment;
a controller with memory for storing device operation and patient data; and
additional sensors for measuring compression, load, strain and plunger motion on the device and patient information, such as pulse, blood pressure, ECG, CO² and oximetry

The CMD includes a plunger-motor feed-back mechanism which enables the fine tuning of the compression of the plunger to be adjusted to the anatomical build of the patient being treated.

The variability of chest stiffness (or elasticity) during CPR which relates to the force applied and depth achieved, as well as variability over time has been noted. (See Elsevier paper, Resuscitation (2007) 72, 364-370, incorporated in its entirety by reference herein) and the apparent contradictory results that can be obtained between manual CPR where a human may vary pressure and depth versus a device-assisted CPR. Thus, a need exists in the industry, and this disclosure contemplates a solution for:
A dynamically-controlled CMD with energy or force storing/enhancing, adapted to vary one or more of plunger depth, force applied or stroke repetition (speed, rate)
A dynamically-controlled CMD device/system/method adapted to vary anterior-posterior sternal displacement (plunger depth) based on parameters discussed hereinbelow. (Reference is made to JAMA Jul. 25, 2008 article “Manual vs Device-Assisted CPR” p 2662, incorporated in its entirety by reference herein.)
A dynamically-controlled CMD device/system/method adapted to vary one or more parameters of the CPR device operation such as plunger depth, force applied, stroke repetition, plunger angle, messages/alarms given to the operator, sampling new patient data or dispensation of medicaments and/or other treatments, combined with CPR device measurements.
A dynamically-controlled CMD device/system/method adapted to vary one or more operating parameters based on an adaptive, learning, expert or other program which receives one or more CPR device operation parameters and measured patient information.

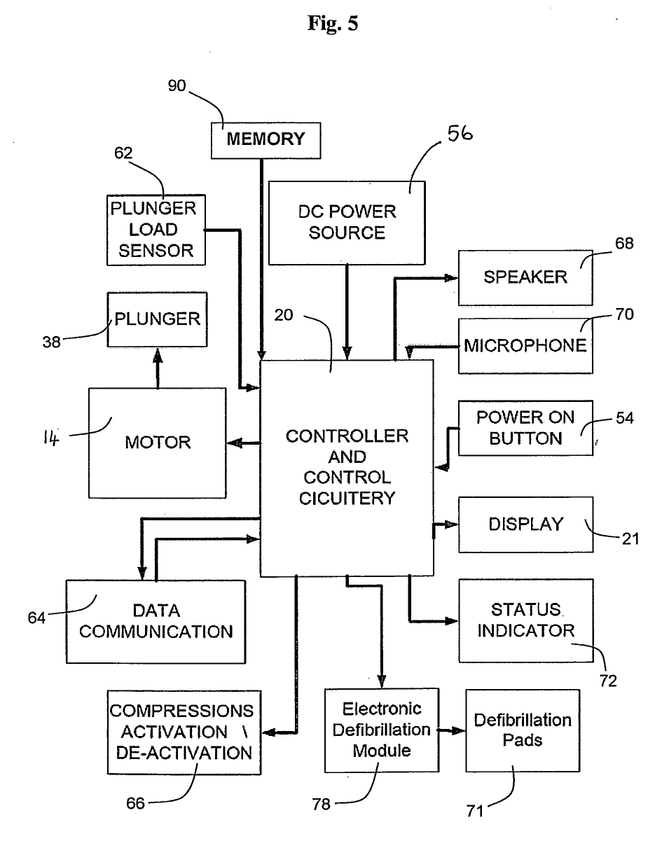

FIGS. 6A and 6B are schematic illustrations of a plunger-type ECM device (or dynamically-controlled CMD) 600, similar in some respects to the CMD device 10 that was described hereinabove. FIG. 6A is an end-on view, and FIG. 6B is a top-down view. Three orthogonal axes, “x”, “y” and “z” are shown. For illustrative clarity, some elements shown in FIG. 6A may be omitted from FIG. 6B. These figures are not mechanical drawings, they are schematic illustrations, and some or all of the elements may not be drawn to scale. Rather, they may be drawn not-to-scale, for illustrative clarity.

The device 600 comprises a base, or platform 602 which is disposed behind a patient's torso. The patient 650 is shown in a supine position, laying on his (or her) back. The patient's torso exerts its weight on the platform 602 to stabilize the device.

An elongated vertical support element 604 extends vertically upward (in the “z” axis) from a side (left, as shown) of the platform 602, past the patient's torso, to a point which is a distance above (and to the side of) the patient's torso. This is a “one-sided” device. Alternatively, there may be a similar vertical support element (not shown) on the other (right, as shown) of the patient's torso, resulting in a “two-sided” device.

An elongated horizontal arm 606 extends, such as in cantilever manner, from a top (as viewed) end of the support element 604, in the horizontal direction (in the “x” axis, as shown), towards the patient's other side (right, as viewed), so that at least a portion of the arm 606 is above the patient's chest. (In the alternative construction with vertical support elements on both sides of the patient's torso, the elongated horizontal arm 606 could be supported at both of its ends, rather than cantilevered.)

A mechanism 608 for imparting motion to a plunger 610 (compare 38, discussed above) is disposed at a distal end of the support arm 606. A linkage 609 is shown between the mechanism 608 and the plunger 610, and may be representative of the driving wheels (86) described hereinabove. With a hydraulic mechanism 608, for example, the linkage 609 may be a piston.

The mechanism 608 may comprise an electric motor (compare 14, discussed above), hydraulic actuators, pneumatic actuators, or any comparable means of imparting force and vertical movement to the plunger 610. The plunger 610 may be operated by any suitable means, such as the driving wheels (86) described hereinabove.

In the device 600, the plunger 610 serves as a “sternum compressing element”, and the mechanism 608 serves as the “mechanism for imparting force” to the sternum compressing element.

The vertical support element 604 may be adjusted (for example, as described hereinabove with respect to elements 30 and 32) so that the plunger 610 can come into contact with the patient's chest, and exert a downward force and resulting displacement.

As discussed above, the plunger 610 may, for example, be a 10 cm in diameter circular plate made of a substantially rigid material and covered by a soft, cushioning and biocompatible material, so as minimize harming the patient during treatment.

One or more device sensors 612 may be associated with the device, as described above, to monitor the workings (operational parameters) of the device. (Compare, for example, load sensor 62, described hereinabove.)

One or more life-sign sensors 614 may be associated with the patient, as described above, to monitor vital signs of the patient. (Compare, for example, life-sign sensor/s, described hereinabove.) These sensors 614 may include, without limitation, one or more of:
a pulse sensor,
an ECG (electrocardiogram) monitoring module
a blood pressure sensor,
a CO2 (carbon dioxide) sensor
an oximetry sensor
a temperature sensor

An electronic controller 620 (compare 20, discussed above) may control operation of the mechanism 608, thereby controlling at least up and down (vertical) movements of the plunger 610, including force, distance and rate, as described hereinabove. A duty cycle of compressions provided by the plunger 610 can also be controlled. (“Duty Cycle” generally refers to a ratio of “on” time versus “off” time, and a duty cycle of other than 50% may be regarded as asymmetric.)

The controller 620 may adaptively control the mechanism in response to signals from the device sensors 612 and life-signs sensors 614, as described hereinabove, and as further described hereinbelow.

A communications module 616 (compare 64, discussed above) may be provided to interface the device with external devices (such as an external defibrillator), download operating instructions, communicate with remote entities (such as off-site doctors), and the like.

A display and human interface module 618 may be provided, which may include such functions as speaker 68, microphone 70, display 21, status indicator 72, discussed above. An interface for defibrillator pads (not shown, compare FIG. 1B) may also be provided, as discussed above.

In use, the plunger 610 moves (at least) up and down in the vertical direction (z-axis) to perform the external cardiac massage, as described hereinabove. And, certain operating parameters of the plunger, such as force, distance and rate may be varied during ECM, as described hereinabove.

The device 600 may also be provided with an energy-accumulating mechanism 644 (compare 44) to assist in performing ECM.

According to an embodiment of the disclosure, various other (other than force, distance and rate) operating parameters of the plunger, such as plunger angle with respect to the patient and position (x-y location) on the patient's chest may additionally or alternatively be varied during ECM.

In FIG. 6A, a position/angle altering mechanism 630 is shown disposed between the mechanism 608 for imparting motion (force) to the plunger 610 and the horizontal arm 606. This position/angle altering mechanism 630 may comprise a mechanism for altering the x-y position and/or stroke angle of the plunger (sternum compressing element). Any suitable mechanism such as screw actuators, may be used to effect the changes in position and/or angle of the plunger. For example, a screw actuator (or threaded rod) extending from a “fixed” first element (such as the arm 606), may move a second “movable” element (such as a mounting bracket for the motor 608) into which it is threaded, when it is rotated turned. Such movement may alter the angle and/or x-y position of the plunger 610. The position/angle altering mechanism 630 may be implemented using any suitable mechanical linkages, including (but not limited to) arms, shafts, wheels, pullies, levers, gears, cams, eccentrics, pinions, trunions and the like.

The CMD shown in FIG. 2 can be modified to provide at least the x-y positioning altering function. For example, the hinge unit 28 can be modified so that the TPBUs 36 can move (travel) back and forth in the x-axis (see arrow, labeled x), and the TPBUs 36 can be modified so the motor 14 can move (travel) back and forth in the y-axis (see arrow, labeled y). These movements may be guided, in a manner similar to riding on rails, and the rails can be arranged so that x-y movement may also be accompanied by some inclination (change in stroke angle) of the plunger 38.

In FIG. 6A, the angle “a” of the plunger 610 is illustrated, and is drawn at 90-degrees, or vertical. The stroke angle of the plunger may be altered (changed), for example, so that the compressions (forces applied to the patient's chest) are delivered other than vertical, such as inclined towards the left or right side of the patient, or towards the neck or waist (abdomen) of the patient. The stroke angle may be changed either prior to or during the course of a ECM treatment.

In FIG. 6A, the position of the plunger 610 is illustrated as being centered (left to right), in the x-axis over the patient's chest. In FIG. 6B, the plunger is illustrated as being located at a given position, in the y-axis, between the neck and waist of the patient 650. The x-y position (location) of the plunger may be altered (changed), for example, so that the compressions are other than at the position shown, such as moved towards the left or right side of the patient, or towards the head or waist of the patient. The x-y position may be changed either prior to or during the course of a ECM treatment. The x-y position may be changed either independently from or in conjunction with changes the stroke angle.

The changes in the plunger angle and/or x-y location on the patient's chest may be implemented in various ways, including for example (and without limitation), on or more of:
implemented by the user (manually)
the device 600 may be programmed to vary the position of the plunger in a pre-determined (prescribed) manner (according to a pre-set pattern)
the device 600 may alter the position of the plunger in response to signals from the sensors 612 and 614 (dynamically varied)

An advantage of changing the plunger's angle and/or position during ECM may be that the ECM procedure may be more effective and/or to reduce incidental damage to surrounding tissue (such as soft tissue).

As an example, during an ECM procedure, which may last many minutes, every few strokes the angle and/or position of the plunger may be altered (changed) slightly, followed by signals from the sensors 612 and 614 being analyzed to determine if the change had beneficial effects, then repeating this procedure until what appears to be an optimal position is located. Any of a number of known algorithms for adaptive control, such as rule-based or history, can be utilized.

As an example, during an ECM procedure, the angle and/or position of the plunger may be altered in response to offline data, such as instructions received from a remote entity.

The changing of the plunger's angle and/or position during ECM may be in conjunction with, rather than in lieu of controlling the plunger's force, distance and rate.

Changes to any of the plunger's force, distance and rate, as well as angle and/or position, may be made by the caregiver (manually).

The depth of the compressions provided by the plunger 610 can also be varied, such as dynamically, by the controller 620. For example,
pre-set patterns may be provided, and selected by the user, for example, increasing the depth of the compressions over a number of compressions, then decreasing the depth
the depth of the compressions may be altered dynamically, increasing or decreasing (in incremental steps, within prescribed limits) over the duration of the ECM procedure (course of treatment), such as in response to the patient's monitored life signs

The speed (repetition rate) of the compressions provided by the plunger 610 can also be varied, such as dynamically, by the controller 620. For example,
pre-set patterns may be provided, and selected by the user, for example, increasing the repetition rate from an initial slow rate to a faster rate, over a number of compressions, thereby allowing time to detect (and correct for) problems
the repetition rate may be altered dynamically, increasing or decreasing (in incremental steps, within prescribed limits) over the duration of the ECM procedure (course of treatment), such as in response to the patient's monitored life signs

The duty cycle of the compressions provided by the plunger 610 can also be varied, such as dynamically, by the controller 620. For example,
rather than a symmetric compression and decompression (releasing pressure), compression can be maintained for a longer (or shorter) period of time before decompressing (releasing pressure)

The “pressure profile” of the compressions provided by the plunger 610 can also be varied, such as dynamically, by the controller 620. For example,
rather than being even and smooth (generally, sine wave), the compressions can be more abrupt (generally, square wave)

The ECM devices disclosed herein are adapted to provide messages and alarms to the operator (rescuer), sample new patient data, dispense medicaments and/or other treatments, perform any measurements related to the procedure, perform defibrillation, and the like.

The electronic controllers of the devices disclosed herein are adapted to perform their functions of varying one or more operating parameters based on an adaptive learning, expert or other program which receives (and is responsive to) one or more of device operation parameters and measured patient information.

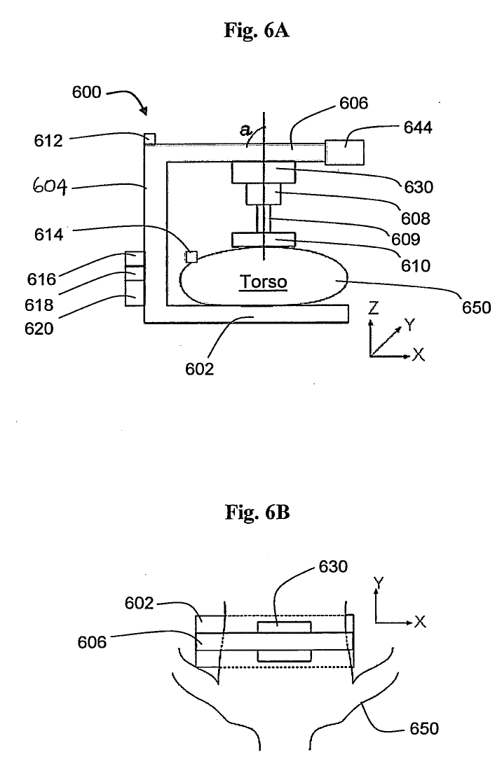

FIGS. 7A and 7B are schematic illustrations two versions of band-type ECM devices 700a and 700b, similar in many respects to the plunger-type ECM device 600 described hereinabove. Both FIGS. 7A and 7B are end-on views, comparable to the end-on view of FIG. 6A. These figures are not mechanical drawings, they are schematic illustrations, and some or all of the elements may not be drawn to scale. Rather, they may be drawn not-to-scale, for illustrative clarity.

Generally, both of the ECM devices 700a and 700b may comprise:
a structural housing element 706 (compare 606) which, in use, will be disposed above the chest of a patient 750
a motion-imparting mechanism 708 (compare 608)
a plunger 710 (compare 610)
a position/angle altering element 730 (compare 630)
one or more device sensors 712 (compare 612)
one or more life-sign sensors 714 (compare 614)
a communications module 716 (compare 616)
a display and human interface module 718 (compare 618)
an electronic controller 720 (compare 620)

The elements 708, 710, 712, 714, 716, 718 and 720 may have substantially the functionality as their counterparts 608-620 in the ECM device 600.

In FIG. 7A, a strap (or band) 742 is shown extending from one side (left, as viewed) of the housing element 706, around the posterior of the patient's torso, to the opposite side (right, as viewed) to secure the device 700a to the patient 750. The strap 742 may be a one or two-piece strap, secured in any suitable manner, such as buckles, hook and loop fastener, and the like. A separate platform (body board) 740a is illustrated, upon which the patient 750 may be positioned and carried. In FIG. 7A, the plunger 710 serves as the “sternum compressing element”, and the mechanism 708 serves as the “mechanism for imparting force” to the sternum compressing element. The strap 742 may be referred to as a “belt” or “cuff”.

In FIG. 7B, two straps (or bands) 742L and 742R are shown extending from the left (as viewed) and right (as viewed) sides of the housing element 706, each to a respective left or right (as viewed) side of a separate platform 740b upon which the patient 750 may be positioned and carried (for supporting the patient). In FIG. 7B, the plunger 710 serves as the “sternum compressing element”, and the mechanism 708 serves as the “mechanism for imparting force” to the sternum compressing element. The straps 742 L and 742R, in aggregate, may be referred to as a “belt” or “cuff”.

The devices 700a and 700b may also be provided with an energy-accumulating mechanism 744a and 744b, respectively, (compare 44) to assist in performing ECM. The energy-accumulating mechanisms discussed herein may also be referred to as “force boosters”.

A mechanism (shown schematically as 743L and 743R) may be included in either or both of the straps 742 L and 742R to independently shorten the respective strap, thereby imparting tension, either evenly or unevenly (at an angle), on the patient's chest, under control of the controller.

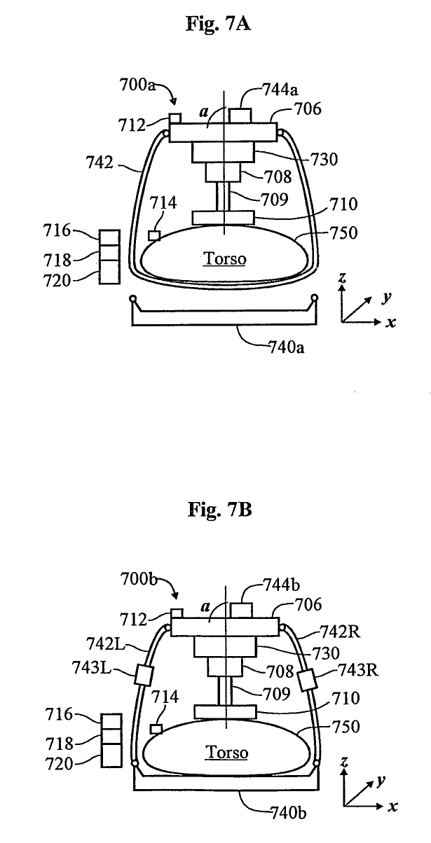

FIGS. 8A and 8B are schematic illustrations two additional versions of band-type ECM devices 800a and 800b which are different than the ECM devices 700a and 700a in that they rely primarily on belt tightening for compression, rather than using a plunger. Both FIGS. 8A and 8B are end-on views. These figures are not mechanical drawings, they are schematic illustrations, and some or all of the elements may not be drawn to scale. Rather, they may be drawn not-to-scale, for illustrative clarity.

Generally, both of the ECM devices 800a and 800b may comprise:
one or more device sensors 812 (compare 712)
one or more life-sign sensors 814 (compare 714)
a communications module 816 (compare 716)
a display and human interface module 818 (compare 718)
an electronic controller 820 (compare 620)

The elements 812, 814, 816, 818 and 820 may have substantially the functionality as their counterparts 712-720 in the ECM devices 700a and 700b.

In FIG. 8A, a “belt-shortening” type device 800a comprises a band (belt, strap) 842 encircles the patient's torso and has two ends inserted into a mechanism 808a adapted to intermittently tighten (shorten, or cinch) the band, thereby resulting in pressure applied on the circumference of the patient's thorax, resulting in cardiac massage without the use of a plunger (such as 710). In FIG. 8A, the belt 842 serves as the “sternum compressing element”, and the mechanism 808a serves as the “mechanism for imparting force” to the sternum compressing element.

In FIG. 8B, a “cuff-tightening” type device 800b comprises a band having a top portion 842t which is hollow and adapted to pass over the patient's chest. A bottom portion 842b of the band passes around the patient's back. The top portion 842t of the band is hollow and can intermittently be inflated with air or a fluid, and a mechanism 808b intermittently inserts pneumatic pressure into the top hollow portion of the band, thereby resulting in pressure applied on the thorax's circumference, resulting in cardiac massage without a plunger (such as 710). In FIG. 8B, the top portion 842t of the band serves as the “sternum compressing element”, and the mechanism 808a serves as the “mechanism for imparting force” to the sternum compressing element.

The devices 800a and 800b may also be provided with an energy-accumulating mechanism 844a and 844b, respectively, (compare 44) to assist in performing ECM. The energy-accumulating mechanisms discussed herein may also be referred to as “force boosters”.

FIG. 8C illustrates that, in either of the embodiments described with respect to FIGS. 8A and 8B, a block of material (compression pad) 844, may be located (disposed) between a portion of the band 842 or 842t passing over the patient's chest, and the patient's chest, substantially over the patient's heart, to direct (localize, focus) pressure at the patient's heart, when the band is cinched or inflated. The block 844 may be a 10 cm in diameter circular plate made of a substantially rigid material and covered by a soft, cushioning and biocompatible material, so as minimize harming the patient during treatment. The block 844 may be a compression pad filled with foam and air.

In both of the devices 800a and 800b, energy is transferred from a mechanism 808a or 808b into linear motion that ultimately change the length of martial\band\strap\cuff in contact with the patient's thorax. The reduction of amount of material in contact results in pressure applied on the thorax's circumferences and thus for the cardiac massage.

In order to achieve this, the driver 808a or 808b can be rotary motor, linear motor, solenoid, pneumatic piston or alike. Any of these means transfers energy via with a spool (in the case of a belt) or a gear to the circumference changing element (belt, cuff). These type of force transfer are inefficient by nature as the force if not transfer to the thorax directly, but rather goes via intermediate mediums\hardware parts (like the spool) that may add friction and residual forces.

Additional Features

In addition to, or alternative to any of the techniques for controlling the operation of an ECM device described herein, a variable-stroke automatic CPR device/system may be implemented that dynamically and intermittently may changes one or more of plunger depth, force applied, stroke repetition (speed), plunger angle, plunger position, temperature or the like based on measured patient information. Such a system may have advantages including (but not limited to):
Measure CPR quality, as by associated patient information, to determine most effective or optimal CPR parameters;
Minimize risk of repetitive-motion injury to affected area;
Permit intermittent, minimal or no force to measure if patient CP function has resumed, to permit independent measurement or treatment, or the like; and
To re-initiate or re-set the force/thrust pattern to better complement the returning heart beat as the patient may re-gain CP function.

Regarding temperature, the pumping action of the ECM device may elevate blood temperature. A certain amount of blood heating may be acceptable, but it may be desired to limit the rise in temperature so that (for example) the patient's brain will not be damaged. Thus, one of the life sign monitors can monitor blood temperature (either directly or indirectly), and the operation of the plunger can be adapted (such as slowed down) so as to maintain blood temperature within a certain limit.

In general, the operation of the sternum compressing element can be controlled in various ways to optimize the ECM and/or to minimize injury to the patient. For example, the repeated pressure of performing ECM at a given location on the patient's chest may cause injury. To minimize such repetitive force injuries, the position of the plunger can be moved around, possibly causing several smaller injuries rather than one major injury.

Other than limiting rise in blood temperature, for example, the x-y position of the plunger can be moved around (as described above) according to a pre-stored pattern so as to make the massage more effective or to reduce incidental injuries to the patient.

Memory

Various CPR devices have been disclosed with associated memory, such as to maintain operating programs, record device operation or measured patient information. However, there appears to be no recognition that device and/or patient information gathered during operation of the device may be useful for later review by health care professionals and/or equipment developers/maintainers on a patient basis, group basis, statistical grouping or other basis.

According to a feature of the disclosure, an ECM device (such as any of the devices described hereinabove) has memory 90 (FIG. 5) to record and retain a coherent (usually time-based) record (data) of device operation and patient condition. The memory 90 may comprise a removable device such as disk, Flash Memory, CD (compact disc) or the like.

Alternatively, the device and patient data may be transmitted to another device such as by wire, wireless, or the like. The other device may comprise an external memory or processor such as a PC (personal computer) or PACS (picture archiving and communication system).

Optionally, a write-once memory device such as one-time-programmable semiconductor memory, may be used to maintain a tamper-proof record of device operation and/or measured patient information which may be useful in malpractice, wrongful death or other forensic matters.

Augmenting Force-Delivery in Belt-Type ECM Devices

As discussed above, various mechanical devices have been proposed for performing ECM. These generally include plunger (or piston type) devices, and belt-type devices.

An embodiment of a plunger-type device, having a mechanism, referred to as “energy-accumulating mechanism” (44) for augmenting force-delivery has been shown and described with respect to FIGS. 1-5. See also the energy-accumulating mechanism 644 (FIG. 6.)

The applicability of energy-accumulating mechanisms 744a, 744b, 844a, 844b to belt-type devices 700a, 700b, 800a, and 800b has also been disclosed, generally (FIGS. 7A, 7B, 8a, 8B).

Belt-type devices typically transfer energy from the mechanism for imparting force (such as rotary motor, linear motor, solenoid, pneumatic piston or the like) to the sternum compressing element (such as belt or cuff) The reduction of amount of material in contact results in pressure applied on the thorax's circumferences, and thus for the cardiac massage. Any of these means transfers energy via with a spool (in the case of a belt) or a gear to the circumference changing element (belt, cuff). These type of force transfer are inefficient by nature as the force is not transferred to the thorax directly, but rather goes via intermediate mediums\hardware parts (like the spool) a that add friction and residual forces.

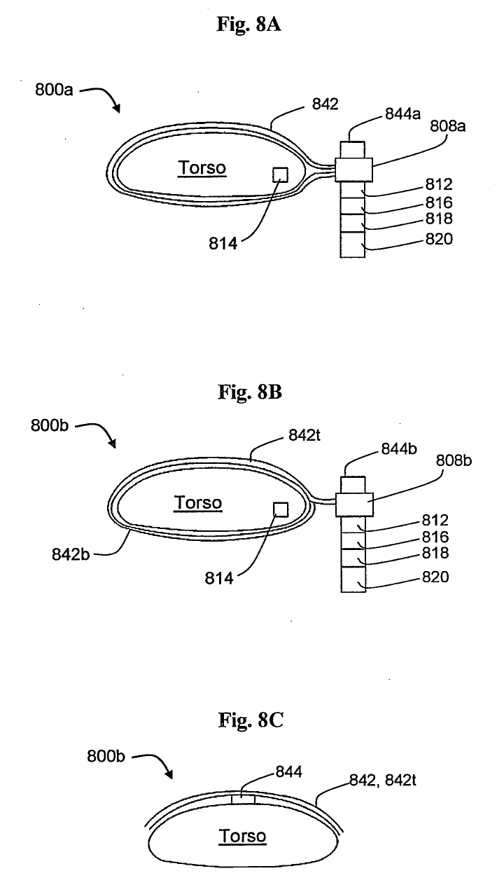

FIG. 9A is a schematic illustration of a band-type ECM device 900 which uses belt-tightening. (Compare FIG. 8A) This figure is not a mechanical drawing, it is a schematic illustrations, and some or all of the elements may not be drawn to scale. Rather, they may be drawn not-to-scale, for illustrative clarity.

A compression band (belt, strap) 942 encircles the patient's torso, and has a right (as viewed) portion 942R and a left (as viewed) portion 942L. The belt 942 serves as the “sternum compressing element”. A block of material (compression pad) 944, may be located (disposed) between a portion of the compression band 942 passing over the patient's chest, and the patient's chest, substantially over the patient's heart, to direct (localize, focus) pressure at the patient's heart, when the band is cinched tight (tightened, as described below). The block 944 may be a 10 cm in diameter circular plate made of a substantially rigid material and covered by a soft, cushioning and biocompatible material, so as minimize harming the patient during treatment. The block 944 may be a compression pad filled with foam and air. The block 944 may have various degrees of resilience, and may be a bladder (of any sort) containing a viscous fluid, including a non-Newtonian fluid.

A platform (or “backboard”) 940 may be provided, for supporting the patient (in a supine position, as shown) and for enclosing (housing) the various mechanical elements and mechanisms of the device 900, as follows. The platform 940 has a central portion 940C between a left (as viewed) portion 940L and a right (as viewed) portion 940R. The platform 940 is wide enough (in the x-axis) to support a patient, and extend beyond such as for grasping the platform to move the patient.

A mechanism 908 for imparting force, such as an electric motor (not shown), drives a drive spindle 909 which may be disposed in the right portion 940R of the platform 940. The spindle 909 may be rotated in a clockwise or counter-clockwise direction, as indicated by the double-headed arrow. A drive band 946, which may be integral with or separate from the compression band 942 is wrapped around and acted upon by the drive spindle 909, and may have a free end. (If “integral”, this implies that the two ends of the compression band 942 engage the drive spindle 909.)

Any number of electronic components, including batteries, electronic controller, communications modules and the like (generally as may have been described hereinabove) may be disposed in the left portion 940L of the platform 940. These components are generally designated 911.

An end portion of the right portion 942R of the compression belt 942 passes around a spindle (or pulley) 943R, and is directed towards the spindle 909. An end portion of the left portion 942L of the compression belt 942 passes around a spindle (or pulley) 943L, and is directed towards the spindle 909. The end portions of the band 942 merge, and may be joined together, to the right of the spindle 943R.

The ends of the left and right portions 942L and 942R of the compression belt 942 may be joined directly to the free end of the drive band 946. In which case, the device 900 can be operated substantially in the manner of existing devices.

Alternatively, as illustrated, an energy-accumulation mechanism (or “force booster”, or “force-modifying” element) 950 may be disposed between the joined together end portions of the left and right portions 942L and 942R of the compression belt 942 and the free end of the drive band 946. In principle, the “force booster” is operatively disposed between the “mechanism for imparting force” and the “sternum compressing element”. Other types of “force modifying” elements are disclosed herein which may be disposed at various locations in the “drive train” from the “mechanism for imparting force” to the “sternum compressing element”.

As illustrated in FIG. 9B, the force booster 950 can be a compression-type spring 954 which is pre-compressed.

Here it can be seen that the ends of the left and right portions 942L and 942R of the compression belt 942 are affixed to the left (as viewed) end of a threaded rod 952. An end plate 953 may be disposed at the left end (as viewed) of the threaded rod 952. The free end of the drive band 946 may be joined to the right (as viewed) end of the threaded rod 952.

The spring 954 may be disposed about the rod 952, which extends through an inner circumference of the spring 954, beyond the right (as viewed) end of the spring 954. A threaded end plate 955 may be disposed on the threaded rod 952. The threaded end plate 955 may be turned so as to pre-compress the spring 954, as indicated by the two arrows facing each other. In this manner, force applied by the drive spindle 909 may be modified, consequently modifying (such as boosting) the compressions on the patient's chest.

Another force-modifying arrangement (including a force-modifying element) is illustrated in FIG. 9C, and may be used either separately or in conjunction with the force-boosting (or force modifying) element 950. As illustrated, the ends of the left and right portions 942L and 942R of the compression belt 942 are joined directly to the free end of the drive band 946.

A fixed anchor point 961 is provided within the backboard (housing) 940. The spindle 943R is mounted so as to be movable (for example, it may be on an axle disposed between two grooves, not shown). When the compression belt 942 is tensioned (such as in response to counter-clockwise rotation of the drive spindle 909), the right portion 942R of the compression belt 942 tends to pull the spindle 943R upwards and to the right. A spring, or dashpot, or other suitable force-modifying element 964 may be disposed between the fixed anchor point 961 and the spindle 943R and, as indicated by the double-headed arrow, the element 964 may boost force in either desired direction. For example, the element 964 may comprise a tension spring which, in the absence of driving (belt-shortening) force, maintains the belt 942 in a pre-compressed state.

FIG. 9D illustrates that a force-altering element 960 such as a shock absorber may be disposed between a portion of the belt 942 passing over the patient's chest and the patient' chest (essentially, “substituted for the” compression pad 944 shown in FIG. 9A). The shock absorber may be a passive (non-powered) element, may comprise a hydraulic reservoir, and may dampen force and/or store energy in one or both directions (up or down stroke), either symmetrically or non-symmetrically.

A torsion spring (not shown) may, for example, be disposed on the drive spindle 909 which biases the drive spindle in one direction or the other (clockwise or counter-clockwise), as well as in both directions.

As indicated by the above, a spring element, a dashpot, a shock absorber or virtually any other force-altering element(s), may be added almost anywhere in the “drive train”. Assuming the torso to be an elastic medium which is being acted upon, the compressions (and rebounds) can be made asymmetrical by the addition of force-altering elements to optimize the efficacy of the massage, or to offset undesired asymmetries in the elasticity of the torso. For example, a spring may be loaded so that when the crank (for example) pushes the plunger downwards, the spring applies force in the same direction.

Whereas the force-altering elements described above may be passive devices, it is within the scope of the disclosure that an active device such as an entire “plunger package” such as described with respect to FIGS. 6A or 7A can be inserted between the belt and the patient's chest (essentially, “substituted for” the compression pad 944 shown in FIG. 9A), including, but not limited to, one or more of the following:
a (second) mechanism for imparting force, or plunger (compare 608, 708)
a linkage (compare 609, 709)
a sternum compressing element, such as a plunger (compare 610, 710) which is acted upon by the second mechanism for imparting force
a position/angle altering mechanism (compare 630, 730) for altering the direction or position of force applied by the plunger to the patient's sternum

Some (or all) of the force-modifying concepts disclosed above (belt-shortening) may be applied to a cuff-tightening ECM device, operated by pneumatic pressure (rather than an electric motor) as a mechanism for imparting force.

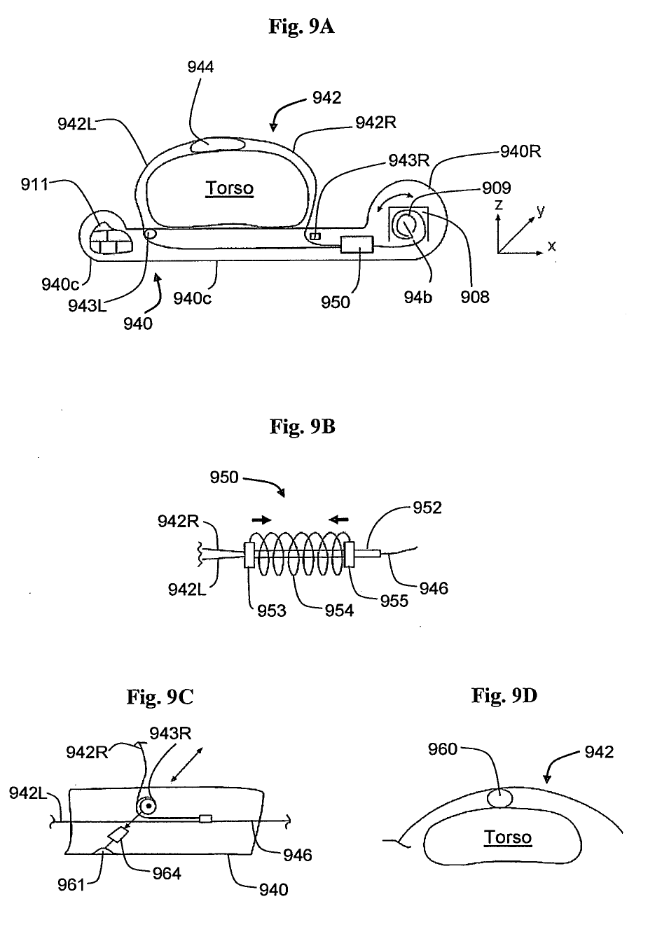

FIG. 10 is a schematic illustration of a band-type ECM device 1000 which uses cuff-tightening (Compare FIG. 8B). This figure is not a mechanical drawing, it is a schematic illustrations, and some or all of the elements may not be drawn to scale. Rather, they may be drawn not-to-scale, for illustrative clarity.

A compression band (including a pneumatic tube portion) 1042 encircles the patient's torso, and may have a top (as viewed) pneumatic portion 1042t and a bottom (as viewed) non-pneumatic portion 1042b. Alternatively, the entire compression band 1042 may be a pneumatic tube. The compression band 1042 serves as the “sternum compressing element”.

A block of material (compression pad) 1044 (compare 944), may be located (disposed) between the portion 1042t of the band 1042 passing over the patient's chest, and the patient's chest, substantially over the patient's heart, to direct (localize, focus) pressure at the patient's heart, when the band is cinched tight (tightened, as described below). The block 1044 may be a 10 cm in diameter circular plate made of a substantially rigid material and covered by a soft, cushioning and biocompatible material, so as minimize harming the patient during treatment. The block 1044 may be a compression pad filled with foam and air. The block 1044 may have various degrees of resilience, and may contain a viscous fluid, including a non-Newtonian fluid.

A platform (or “backboard”) 1040 may be provided, for supporting the patient (in a supine position, as shown) and for enclosing (housing) the various mechanical elements and mechanisms of the device 1000, as follows. The platform 1040 has a central portion 1040C between a left (as viewed) portion 1040L and a right (as viewed) portion 1040R. The platform 1940 is wide enough (in the x-axis) to support a patient, and extend beyond such as for grasping the platform to move the patient.

A mechanism 1008 for imparting force, such as a pneumatic pump (not shown), provides pressurized air or fluid into the pneumatic portion 1042t of the belt 1042.

Various valves, petcocks, dampers and the like, generally designated 1009 may be provided in fluid communication between the pump and the pneumatic portion of the belt, for controlling (modifying, altering, enhancing) the flow of air or fluid into the pneumatic (inflatable) belt portion 1042t. these elements 1009 may also permit venting pressure from the pump 1008 and/or pneumatic belt portion 1042t. These elements 1009 may act as an energy-accumulation mechanism (or “force booster”, or “force-modifying” element).

Any number of electronic components, including batteries, electronic controller, communications modules and the like (generally as may have been described hereinabove) may be disposed in the left portion 1040L of the platform 1040. These components are generally designated 1011.

The non-pneumatic bottom portion 1042b of the band 1042 may simply be attached to the left portion 1042L of the platform 1040. Alternatively, the non-pneumatic bottom portion 1042b of the band 1042 may enter the platform (housing) 1040, may pass around a spindle 1043L (compare 943L) and be connected via an energy-accumulation mechanism (or “force booster”, or “force-modifying” element) 1050 (compare 950) to a fixed point 1051 within the platform housing 1040. And, the spindle 1043L may be connected via a spring, or dashpot, or other suitable force-modifying element 1064 (compare 964) to a fixed anchor point (1061) compare 961) within the platform housing 1040.

FIG. 9A illustrated a belt-shortening ECM device 900, and FIG. 10 illustrated a cuff-tightening ECM device 1000.

A “hybrid” device, using belt-shortening and cuff-tightening could be formed, for example, by substituting a motor drive mechanism (comparable to 908, 909L; FIG. 9A) for the mechanism 1050 (FIG. 10), resulting in the left (as viewed) portion of the belt being belt-shortening, and the right (as viewed) portion of the belt being pneumatic cuff-tightening.

Alternatively, a substantially entire belt-shortening mechanism (including belt), as shown in FIG. 9A, could be superimposed over (or under) a substantially entire cuff-tightening mechanism (including belt), as shown in FIG. 10. An advantage of combining the “pneumatic” and the “mechanical” may be more efficient and/or effective control over the massage, plus some redundancy.

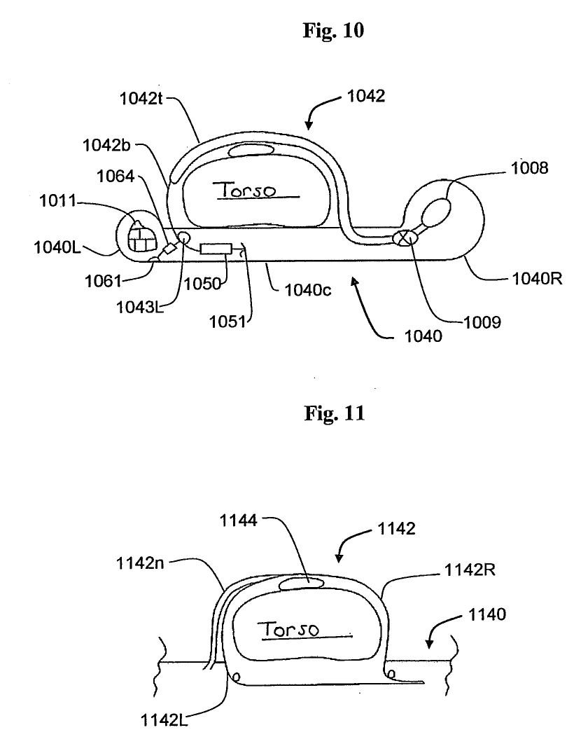

FIG. 11 illustrates (partially) a “hybrid” ECM device 1100, which may incorporate some or all of the features of the belt-shortening ECM device 900 of FIG. 9A and the cuff-tightening device 1000 of FIG. 10. Generally, the device 1100 comprises:
a belt 1142 at least partially encircling a patient's chest:
a mechanism (not shown, see 908, for example) for intermittently tightening the belt;
a pneumatic element 1144 disposed between the belt 1142 and the patient's chest; and
a mechanism (not shown, see 1008, for example) for intermittently pressurizing the pneumatic tube.

A compression band (belt, strap) 1142 (compare 942) encircles the patient's torso, and has a right (as viewed) portion 1142R and a left (as viewed) portion 1142L. The belt 1142 serves as the “sternum compressing element”. The band 1142 may be intermittently tightened (and loosened) by an electric motor and associated elements (not shown, see motor 908 and spindle 909, for example, in FIG. 9A), for performing cardiac massage.

An inflatable pneumatic bladder 1144 (compare compression pad 944) may be located (disposed) between a portion of the band 1142 passing over the patient's chest, and the patient's chest, substantially over the patient's heart. The bladder may be (for example) approximately 10 cm in diameter.

A pneumatic tube 1042n, which need not serve any structural (mechanical) function, communicated fluid (including air) pressure from a pneumatic source (not shown) which may be disposed within the platform (housing) 1149 (compare 1008 disposed in 1040; FIG. 10).

The bladder 1044 may be intermittently inflated (and deflated), for performing cardiac massage.

Generally, the bladder 1044 may be operated independently of the belt 1142, in various ways:
the bladder may be intermittently inflated during a belt-tightening “stroke”, to augment the chest compression
the bladder may be inflated with a constant pressure, simply to modify the cardiac massage
the bladder may be intermittently inflated to perform the cardiac massage in the event of a failure of the belt-tightening mechanism

In the description and claims of the application, each of the words “comprise” “include” and “have”, and forms thereof, are not necessarily limited to members in a list with which the words may be associated.

The disclosure has been described using various detailed descriptions of embodiments thereof that are provided by way of example and are not intended to limit the scope of the disclosure. The described embodiments may comprise different features, not all of which are required in all embodiments of the disclosure. Some embodiments of the disclosure utilize only some of the features or possible combinations of the features. Variations of embodiments of the disclosure that are described and embodiments of the disclosure comprising different combinations of features noted in the described embodiments will occur to persons with skill in the art. It is intended that the scope of the disclosure be limited only by the claims and that the claims be interpreted to include all such variations and combinations.

What is claimed is:

1. An external cardiac massage (ECM) device comprising:
a sternum compressing element adapted to be positioned on a patient's chest for massaging the patient's heart;
a mechanism for imparting force to the sternum compressing element; and
a force booster disposed in a drive train from the mechanism for imparting force to the sternum compressing element.

2. The ECM device of claim 1, wherein:
the force booster comprises a compression-type spring.

3. The ECM device of claim 2, wherein:
the spring is pre-compressed.

4. The ECM device of claim 1, further comprising:
one or more force modifying elements disposed in the drive train from the mechanism for imparting force to the sternum compressing element.

5. The ECM device of claim 1, wherein:
the force booster comprises an energy-accumulation mechanism.

6. The ECM device of claim 1, wherein:
the force booster comprises a force-modifying element.

7. The ECM device of claim 1, further comprising:
a force-modifying element adapted to be used in conjunction with the force-boosting element.

8. The ECM device of claim 1, further comprising:
a controller for controlling movement of the sternum compressing element.

9. The ECM device of claim 1, wherein:
the sternum compressing element comprises a compression band adapted to at least partially encircles a patient's torso.

10. The ECM device of claim 9, further comprising:
a block of material adapted to be portion of the compression band passing over the patient's chest, and the patient's chest.

11. The ECM device of claim 10, wherein:
the block of material comprises a compression pad.

12. The ECM device of claim 10, wherein:
the block of material comprises a viscous fluid.

13. The ECM device of claim 12, wherein:
the viscous fluid comprises a non-Newtonian fluid.

14. The ECM device of claim 1, wherein:
the mechanism for imparting force is selected from the group consisting of rotary motor, linear motor, solenoid, and pneumatic piston.

15. The ECM device of claim 1, wherein the sternum compressing element comprises a belt.

16. The ECM device of claim 15, further comprising:
a force-altering element disposed between a portion of the belt passing over the patient's chest and the patient' chest.

17. The ECM device of claim 16, wherein:
the force-altering element comprises a shock absorber.

18. The ECM device of claim 16, wherein:
the force-altering element is adapted to dampen force in at least one direction.

19. The ECM device of claim 16, wherein:
the force-altering element is adapted to store energy in at least one direction

20. The ECM device of claim 15, further comprising:
a drive spindle for intermittently tightening the belt.

21. The ECM device of claim 20, further comprising:
a torsion spring disposed on the drive spindle.

22. The ECM device of claim 15, wherein:
at least a portion of the belt comprises a pneumatic tube portion

23. The ECM device of claim 1, further comprising:
a backboard adapted to support the patient in a supine position and for housing various mechanical elements and mechanisms of the device.

24. The ECM device of claim 1, wherein:
the mechanism for imparting force comprises a pump providing pressurized air or fluid to a pneumatic portion of the belt.

25. The ECM device of claim 24, further comprising:
a force-modifying element disposed in fluid communication between the pump and the pneumatic portion of the belt.

26. The ECM device of claim 25, wherein:
said force-modifying element is selected from the group consisting of valves, petcocks, and dampers.

27. An external cardiac massage (ECM) device comprising:
a belt or cuff at least partially encircling a patient's chest:
a mechanism for in intermittently tightening the belt or cuff;
a plunger package disposed between the belt or cuff and the patient's chest, said plunger package comprising at least one of:
a second mechanism for imparting force to the plunger;
a plunger acted upon by the second mechanism for imparting force; and
a position/angle altering mechanism adapted to alter a direction or position of force applied by the plunger to the patient's chest.

28. An external cardiac massage (ECM) device comprising:
a belt or cuff at least partially encircling a patient's chest:
a mechanism for in intermittently tightening the belt or cuff;
a pneumatic tube disposed between the belt or cuff and the patient's chest; and
a mechanism for intermittently pressurizing the pneumatic tube.

29. An external cardiac massage (ECM) device comprising:
a sternum compressing element adapted to be positioned over a patient's thorax for externally massaging the patient's heart; a mechanism for imparting force to the sternum compressing element;
a controller for controlling movement of the sternum compressing element; and
memory to record and retain a coherent (usually time-based) record (data) of device operation and patient condition.

30. The ECM device of claim 29, wherein:
the memory is selected from the group consisting of disk, Flash Memory and compact disc (CD).
